(19) United States
(12) Patent Application Publication
(10) Pub. No.: US 2023/0354188 A1
(43) Pub. Date: Nov. 2, 2023

(54) DISCONTINUOUS RECEPTION BY BASE STATION FOR ENERGY SAVING

(71) Applicant: QUALCOMM Incorporated, San Diego, CA (US)

(72) Inventors: Naeem AKL, Bridgewater, NJ (US); Navid ABEDINI, Basking Ridge, NJ (US); Jianghong LUO, Skillman, NJ (US); Tao LUO, San Diego, CA (US); Junyi LI, Fairless Hills, PA (US); Ozcan OZTURK, San Diego, CA (US)

(21) Appl. No.: 18/304,091

(22) Filed: Apr. 20, 2023

Related U.S. Application Data
(60) Provisional application No. 63/363,801, filed on Apr. 28, 2022.

(51) Int. Cl. H04W 52/02; H04W 76/28

(52) U.S. Cl. CPC H04W 52/0206; H04W 52/0216; H04W 76/28

(57) ABSTRACT

Aspects are provided which allow a network entity to receive an uplink transmission from a UE in UE DTX or cell DRX based on dynamic activation or deactivation of a DTX configuration or an associated uplink transmission configuration with respect to DTX. In some examples, the UE receives a DTX configuration associated with a UE transmission configuration and indicating an active time duration for a UE transmission associated with the UE transmission configuration. The UE also receives the uplink transmission configuration, such as an SR configuration, and a semi-static or dynamic indication of an active status of the DTX configuration or the uplink transmission configuration with respect to the DTX configuration. Afterwards, the UE transmits the UE transmission during the active time duration indicated in the DTX configuration based on the active status. As a result, less uplink transmission monitoring may result at the base station, providing network energy savings.

### CROSS REFERENCE TO RELATED APPLICATION(S)

This application claims the benefit of U.S. Provisional Application Ser. No. 63/363,801, entitled “DISCONTINUOUS RECEPTION BY BASE STATION FOR ENERGY SAVING” and filed on Apr. 28, 2022, the disclosure of which is expressly incorporated by reference herein in its entirety.

### TECHNICAL FIELD

The present disclosure generally relates to wireless communication, and more particularly, to a wireless communication system providing cell discontinuous reception (DRX).

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The UE receives a discontinuous transmission (DTX) configuration associated with a UE transmission and indicating an active time duration for the UE transmission, and transmits the UE transmission during the active time duration indicated in the DTX configuration.

In an aspect of the disclosure, a method, a computer-readable medium, and an apparatus are provided. The apparatus may be a network entity such as a base station. The network entity transmits a DTX configuration associated with a UE transmission and indicating an active time duration for the UE transmission, and receives the UE transmission during the active time duration indicated in the DTX configuration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of discontinuous reception (DRX) at the UE.

FIG. 5 is a diagram illustrating an example of a call flow between a UE and a base station in which the UE transmits a SR to the base station.

FIGS. 6A and 6B are diagrams respectively illustrating examples of SR occasions and configured grant occasions which a base station may configure for a UE.

FIG. 7 is a diagram illustrating an example of SR resource configurations for a UE which a base station may dynamically activate and deactivate.

FIG. 8 is a diagram illustrating an example of SR occasions and configured grant occasions that a base station may respectively configure for a UE to apply while performing discontinuous transmission (DTX).

FIG. 9 is a call flow diagram between a UE and a base station.

FIG. 10 is a flowchart of a method of wireless communication at a UE.

FIG. 11 is a flowchart of a method of wireless communication at a base station.

FIG. 12 is a diagram illustrating an example of a hardware implementation for an example apparatus.

FIG. 13 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects generally relate to cell discontinuous reception (DRX). More particularly, aspects specifically relate to a wireless communication system in which a network entity such as a base station provides to a user equipment (UE) a discontinuous transmission (DTX) configuration associated with an uplink transmission configuration to provide network energy savings. These aspects reduce energy consumption at the base station by allowing the base station to avoid actively and blindly monitoring off durations in DTX cycles for associated, unscheduled or unused uplink transmissions such as scheduling requests (SRs) or configured grant (CG) physical uplink shared channel (CG-PUSCH) transmissions. Some examples of these aspects generally relate to semi-static or dynamic activation or inactivation of the DTX configuration. These examples allow for maximum energy savings at the base station by allowing the base station to refrain from monitoring uplink transmissions in general during off durations of DTX cycles when the DTX configuration is active. Other examples of these aspects specifically relate to semi-static or dynamic activation or inactivation of the uplink transmission configuration with respect to the DTX configuration. These examples provide flexibility to the base station to configure certain uplink transmission configurations, such as CG-PUSCH or SR configurations associated with high priority logical channels or delay sensitive traffic, to be inactivated or excepted from DTX so that latency-sensitive data may not be delayed by DTX off durations, while other uplink transmission configurations, such as SR configurations associated with low priority logical channels for delay tolerant traffic, may be activated or subject to DTX to allow the base station to still obtain network energy savings. Additional examples relate to dynamic activation or inactivation of uplink transmission configurations irrespective of DTX configurations. In any of these aspects and examples previously described and to be described, the DTX configuration may refer to a UE DTX configuration or a cell DRX configuration.

In some examples, the base station may dynamically activate or deactivate SR configurations, and thus SR transmissions, via layer 1 (L1) or layer 2 (L2) signaling, irrespective of DTX configurations. For instance, after the base station configures an SR configuration for the UE via a radio resource control (RRC) configuration, the base station may transmit a message via L1 or L2 signaling to the UE which activates or deactivates the SR configuration. In another example, after the base station configures an SR resource configuration for a UE via an RRC configuration, the base station may transmit a message via L1 or L2 signaling to the UE which activates or deactivates the SR resource configuration. In other examples, the base station may configure parameters associated with an SR configuration or SR resource configuration in message(s) or L1/L2 signaling for activating or deactivating SR transmissions. In a further example, the base station may configure the message to modify logical channel parameters associated with an SR configuration. The activation and deactivation may be specific to one configuration or transmission, or the activation and deactivation may apply to a multitude of SR configurations or transmissions. Similarly, the activation and deactivation may be specific to one UE, or the activation and deactivation may be multicast or broadcast signaled to a cell including multiple UEs. In other examples, the base station may configure multiple PUCCH resources for an SR on a given bandwidth part (BWP), so that even if the base station deactivates one PUCCH resource for a SR, the SR may have at least one other PUCCH resource available for the UE to apply. In other examples, the base station may not activate or deactivate an SR occasion, but instead reconfigure that SR occasion using L1/L2 signaling. In any of the foregoing examples, the base station may indicate a time upon which activation, deactivation, or reconfiguration of an SR configuration, SR resource configuration, logical channel configuration, or other SR-associated configuration takes effect via L1/L2 signaling. In any of the foregoing examples, the base station may dynamically activate, deactivate, or reconfigure an SR configuration or SR-associated configuration based on one or more UE capabilities. The base station may similarly apply any of the foregoing concepts to CG configurations for configured grant type 1 and configured grant type 2.

Additionally, in other examples, a base station may provide a semi-static DTX configuration to a UE. In response to receiving the DTX configuration, the UE may transmit in valid resources falling within activity intervals indicated in the DTX configuration while discontinuing transmissions outside these intervals while the DTX configuration is active. The base station may activate or deactivate a DTX configuration semi-statically via RRC signaling or dynamically via L1 or L2 signaling. As a result, the UE may transmit an uplink transmission in general during an on duration but not during an off duration of a DTX cycle when the DTX configuration is active, while the UE may disregard the DTX cycle and transmit uplink transmissions in the off duration when the DTX configuration is inactive. Moreover, the base station may apply any of the foregoing example concepts of activation, deactivation, and reconfiguration described with respect to SR and CG-PUSCH configurations in connection with DTX. For example, the base station may dynamically via L1 or L2 signaling, or semi-statically via RRC signaling, select to activate, deactivate, or reconfigure an SR configuration, SR resource configuration, CG configuration, or other uplink transmission configurations with respect to the DTX configuration. As a result, during an on duration but not during an off duration of a DTX cycle when the particular configuration is active, the UE may transmit SR transmissions in general, SR transmissions associated with a specific SR configuration, CG-PUSCH transmissions in general, CG-PUSCH transmissions associated with a specific CG-PUSCH configuration, random access channel (RACH) transmissions, or the like depending on the particular configuration. On the other hand, when the particular configuration is inactive, the UE may disregard the DTX cycle and transmit in the off duration the SR, CG-PUSCH, RACH, or other transmission associated with that particular configuration. Furthermore, in other examples, the base station may apply L1 or L2 signaling to interrupt or cancel a first active time indicated by a DTX configuration, the base station may reconfigure parameters of a DTX configuration via L1 or L2 signaling, the base station may define one or more UE capabilities for support of one or more DTX configurations, or the base station may indicate at least one parameter of a DTX configuration via a system information block (SIB) or multi-cast signaling.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

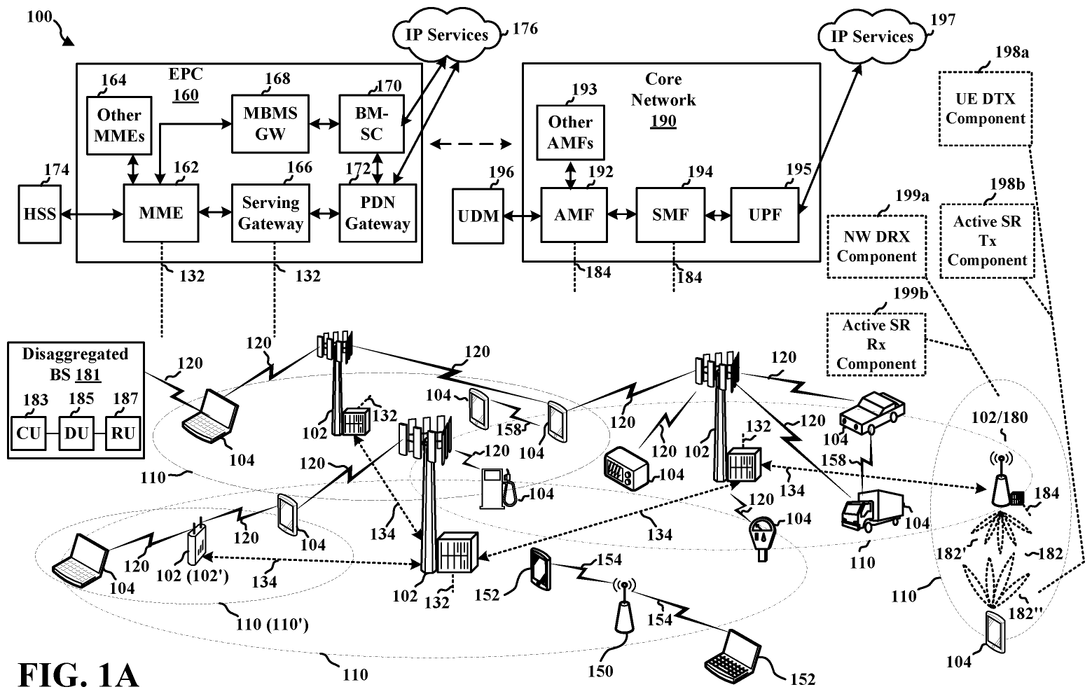

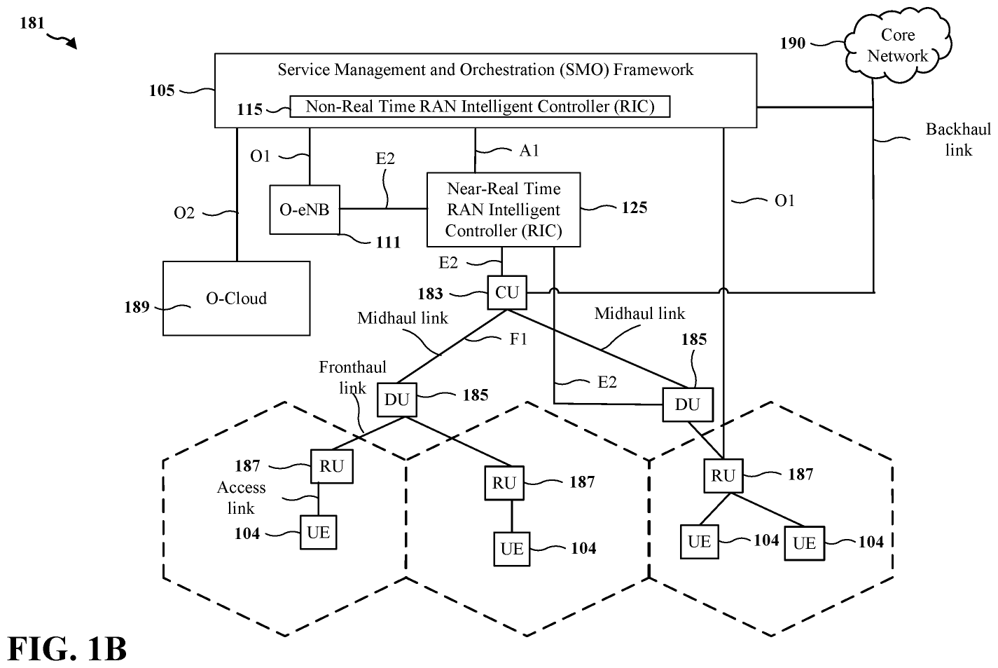

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B shows a diagram illustrating an example disaggregated base station 181 architecture. The disaggregated base station 181 architecture may include one or more CUs 183 that can communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 can be logically split into one or more CU-UP units and one or more CU-CP units. The CU-UP unit can communicate bidirectionally with the CU-CP unit via an interface, such as the E1 interface when implemented in an O-RAN configuration. The CU 183 can be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 185 may further host one or more low PHY layers. Each layer (or module) can be implemented with an interface configured to communicate signals with other layers (and modules) hosted by the DU 185, or with the control functions hosted by the CU 183.

Lower-layer functionality can be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 can be implemented to handle over the air (OTA) communication with one or more UEs 104. In some implementations, real-time and non-real-time aspects of control and user plane communication with the RU(s) 187 can be controlled by the corresponding DU 185. In some scenarios, this configuration can enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements can include, but are not limited to, CUs 183, DUs 185, RUs 187 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

Referring again to FIG. 1A, in certain aspects, the UE 104 may include a UE DTX component 198a which is configured to receive a DTX configuration associated with a UE transmission and indicating an active time duration for the UE transmission; and transmit the UE transmission during the active time duration indicated in the DTX configuration. Similarly, the base station 102/180 may include a NW DRX component 199a which is configured to transmit a DTX configuration associated with a UE transmission and indicating an active time duration for the UE transmission; and receive the UE transmission during the active time duration indicated in the DTX configuration. The DTX configuration referenced in either component may be a UE DTX configuration or a cell DRX configuration. Thus, the UE transmission may be, for example, an SR, a CG-PUSCH transmission, or other uplink transmission which the UE 104 or UE DTX component 198a may transmit and the base station 102/180 or NW DRX component 199a may receive during the active time duration or on duration of a UE DTX cycle or cell DRX cycle configured in the DTX configuration. In some examples, the DTX configuration may be activated or inactivated semi-statically or dynamically with respect to UE transmissions. For instance, the DTX configuration or other RRC message may semi-statically indicate a DTX active status, or a DCI or medium access control (MAC) control element (MAC-CE) may dynamically indicate a DTX active status, which indicates whether the DTX configuration is active or inactive. If the DTX active status is active, the UE may transmit and the base station may receive uplink transmissions during the on duration but not in an off duration of the UE DTX cycle or cell DRX cycle. If the DTX active status is inactive, the UE and base station may disregard the UE DTX cycle or cell DRX cycle and thus the UE may transmit and the base station may receive even in the off duration.

In some examples, the UE transmission or a configuration associated with the UE transmission may be activated or inactivated with respect to the DTX configuration. For instance, the UE 104 may also include an active SR transmission component 198b which is configured to receive a SR configuration, to receive a message indicating an active status of the SR configuration, where the active status indicates whether the SR configuration is active or inactive, and to transmit a SR associated with the SR configuration based on the message. Similarly, the base station 102/180 may also include an active SR reception component 199b which is configured to transmit a SR configuration, to transmit a message indicating an active status of the SR configuration, where the active status indicates whether the SR configuration is active or inactive, and to receive a SR associated with the SR configuration based on the message. If the message indicates the SR configuration is active with respect to the DTX configuration, the UE 104 may transmit and the base station 102/180 may receive the SR in an on duration but not in an off duration of a UE DTX cycle or cell DRX cycle configured in the DTX configuration. If the SR configuration is inactive with respect to the DTX configuration, the UE 104 and base station 102/180 may disregard the UE DTX cycle or cell DRX cycle and thus the UE may transmit and the base station may receive the SR even in the off duration.

The aforementioned concepts may similarly apply to other configurations associated with UE transmissions such as configured grant configurations for CG-PUSCH transmissions. Moreover, these concepts may similarly apply to SRs, CG-PUSCH transmissions, or other uplink transmissions independently of DTX configurations. For instance, if the message indicates the SR configuration is active irrespective of a DTX configuration, the UE 104 may transmit and the base station 102/180 may receive the SR in an on duration or an off duration of a UE DTX cycle or cell DRX cycle configured in the DTX configuration, while if the message indicates the SR configuration is inactive irrespective of a DTX configuration, the UE may not transmit and the base station may not receive the SR even in the on duration.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

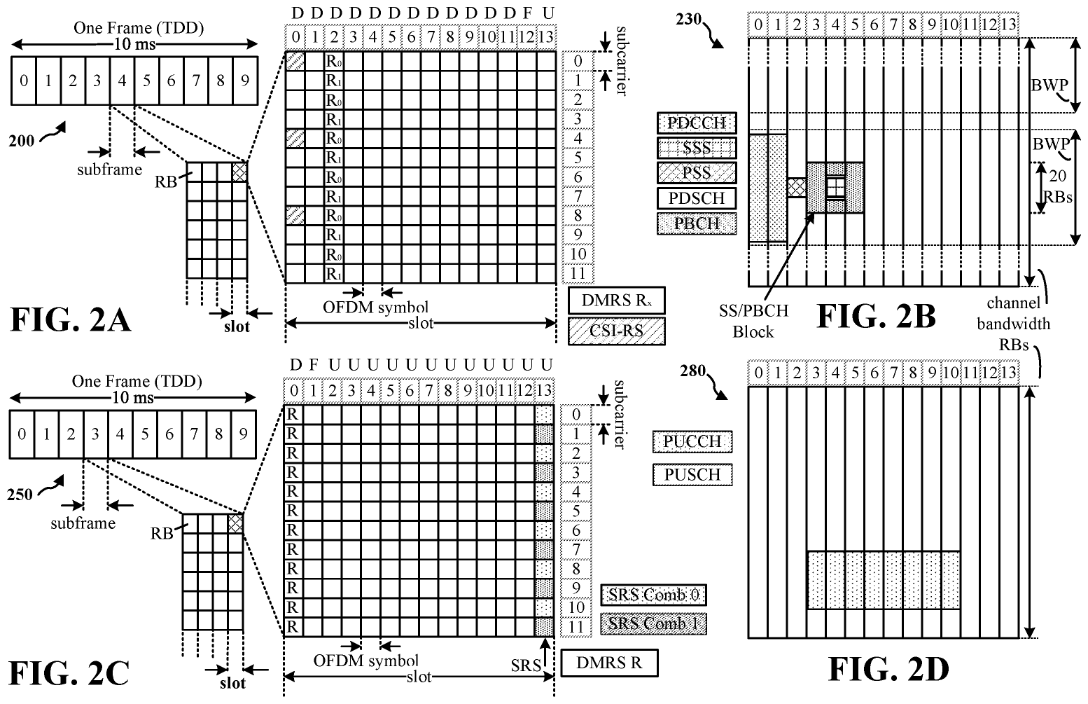

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

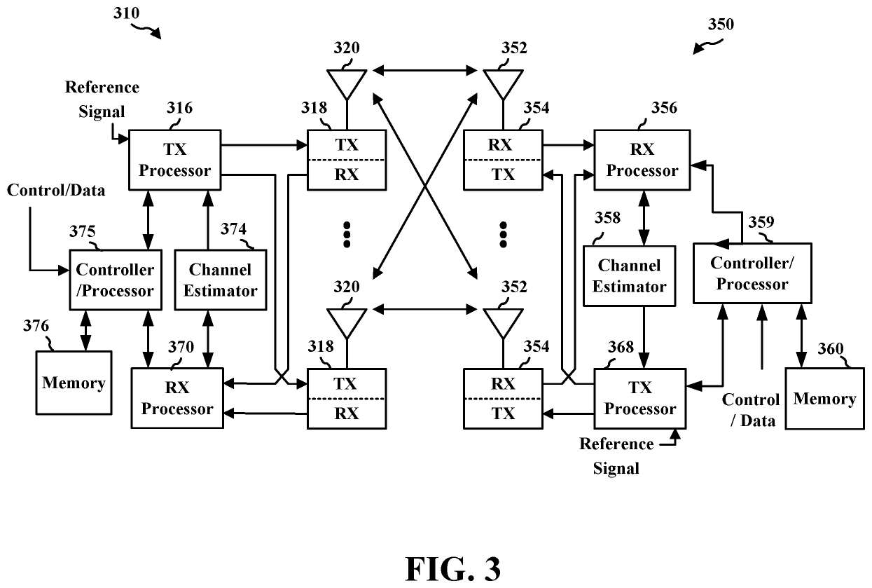

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with UE DTX component 198a and active SR transmission component 198b of FIG. 1A.

At least one of the TX processor 316, the RX processor 370, and the controller/processor 375 may be configured to perform aspects in connection with NW DRX component 199a and active SR reception component 199b of FIG. 1A.

When a UE performs discontinuous reception (DRX), the UE generally monitors the radio channel periodically for a physical downlink control channel (PDCCH) during an active or “on” duration and powers down most of its circuitry to save battery life during an “off” duration. The base station may configure a medium access control (MAC) entity of the UE with this DRX functionality via an RRC configuration, which DRX functionality controls the PDCCH monitoring activity of the UE for one of many radio network temporary identifiers (RNTIs) of the MAC entity in the PDCCH. The RRC configuration may control DRX operation through multiple parameters, including, for example, an on duration timer (the duration at the beginning of a DRX cycle), a slot offset (the delay before starting the on duration timer), an inactivity timer (the duration after the PDCCH occasion in which a PDCCH indicates a new uplink or downlink transmission for the MAC entity), a downlink retransmission timer (the maximum duration until a downlink retransmission is received, per downlink HARQ process), an uplink retransmission timer (the maximum duration until a grant for an uplink retransmission is received, per uplink HARQ process), a long cycle start offset (the long DRX cycle and start offset which defines the subframe where the long and short DRX cycle starts), an optional short cycle (the short DRX cycle), and an optional short cycle timer (the duration the UE shall follow the short DRX cycle). When the UE is in an RRC connected mode (RRC_CONNECTED) and if DRX is configured, then for all the activated serving cells of the UE, the MAC entity of the UE may monitor the PDCCH discontinuously. As a result, the UE may save power through discontinuous PDCCH monitoring. Moreover, the serving cells of the MAC entity may be configured via the RRC configuration in two DRX groups with separate DRX parameters. When the RRC configuration does not configure a secondary DRX group, there is only one DRX group and all serving cells of the MAC entity belong to that one group. When two DRX groups are configured, each serving cell is uniquely assigned to either of the two groups.

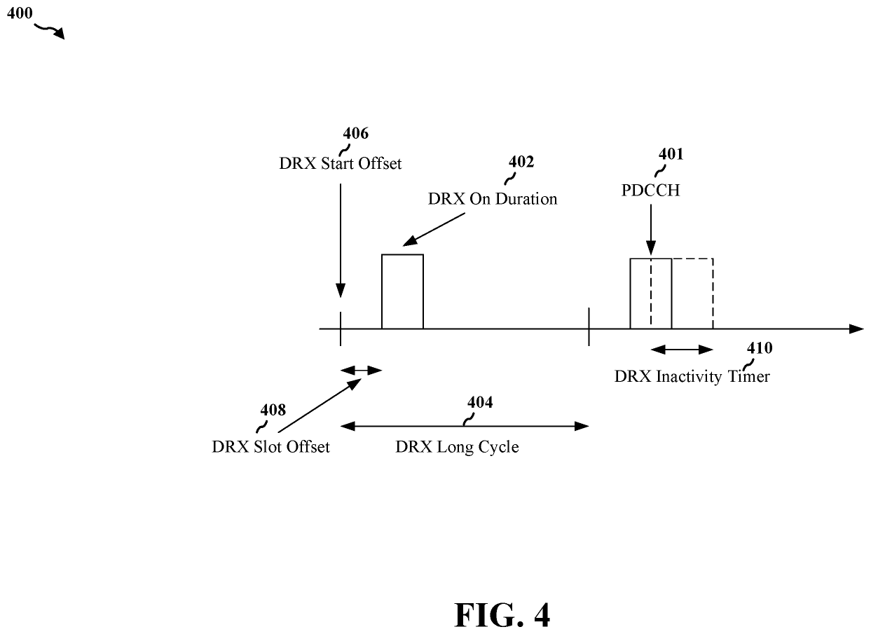

FIG. 4 illustrates an example 400 of DRX reception at the UE. The UE may monitor for a PDCCH 401 during a DRX on duration 402 within a DRX long cycle 404. The DRX long cycle may begin at a time given by DRX start offset 406, and the DRX on duration may begin at a time given by DRX slot offset 408. If the UE detects PDCCH 401 within the DRX on duration 402, the UE may continue monitoring for activity within a DRX inactivity timer 410. The UE may be configured with these and other DRX parameters in an RRC configuration from the base station.

When the UE is in the DRX on duration and currently has data to transmit to the base station, the UE may transmit a scheduling request (SR) to the base station. The SR may inform the base station that the UE is requesting uplink shared channel (UL-SCH) resources for a new uplink transmission. For example, the UE may be triggered to transmit the SR in response to a buffer status report (BSR) procedure, secondary cell (SCell) beam failure recovery, or consistent listen-before-talk (LBT) failure recovery. The MAC entity of the UE may be configured with zero, one or more SR configurations. An SR configuration may include a set of PUCCH resources for transmitting a SR across different bandwidth parts (BWPs) and cells of the UE. Typically, at most one PUCCH resource for transmitting a SR is configured per BWP for a logical channel, for SCell beam failure recovery, or for consistent LBT failure recovery. Moreover, each SR configuration may correspond to one or more logical channels, SCell beam failure recovery, or consistent LBT failure recovery, each of which may be mapped to zero or one SR configuration configured by RRC.

The base station may configure, for each SR configuration, at least the following parameters for a scheduling request procedure: a prohibit timer (which prevents a subsequent SR transmission for a period of time after a given SR transmission), and a maximum number of SR transmissions. The UE may transmit SR only on valid PUCCH resources, which may include PUCCH resources on a BWP which is active at the time of an SR transmission occasion. The maximum number of SR configurations for each cell group of the UE is currently 8, and the maximum number of SR resources for each BWP in a cell is currently 8, although these maximums may be subject to change. The base station may also configure a SR resource configuration, for each SR configuration, which indicates the SR periodicity depending on an applied subcarrier spacing (SCS). For example, any of the following SR periodicities may be configured depending on the SCS, where “sym” refers to a symbol and “sl” refers to a slot:
SCS=15 kHz: 2 sym, 7 sym, 1 sl, 2 sl, 4 sl, 5 sl, 8 sl, 10 sl, 16 sl, 20 sl, 40 sl, 80 sl
SCS=30 kHz: 2 sym, 7 sym, 1 sl, 2 sl, 4 sl, 8 sl, 10 sl, 16 sl, 20 sl, 40 sl, 80 sl, 160 sl
SCS=60 kHz: 2 sym, 7 sym/6 sym, 1 sl, 2 sl, 4 sl, 8 sl, 16 sl, 20 sl, 40 sl, 80 sl, 160 sl, 320 sl
SCS=120 kHz: 2 sym, 7 sym, 1 sl, 2 sl, 4 sl, 8 sl, 16 sl, 40 sl, 80 sl, 160 sl, 320 sl, 640 sl

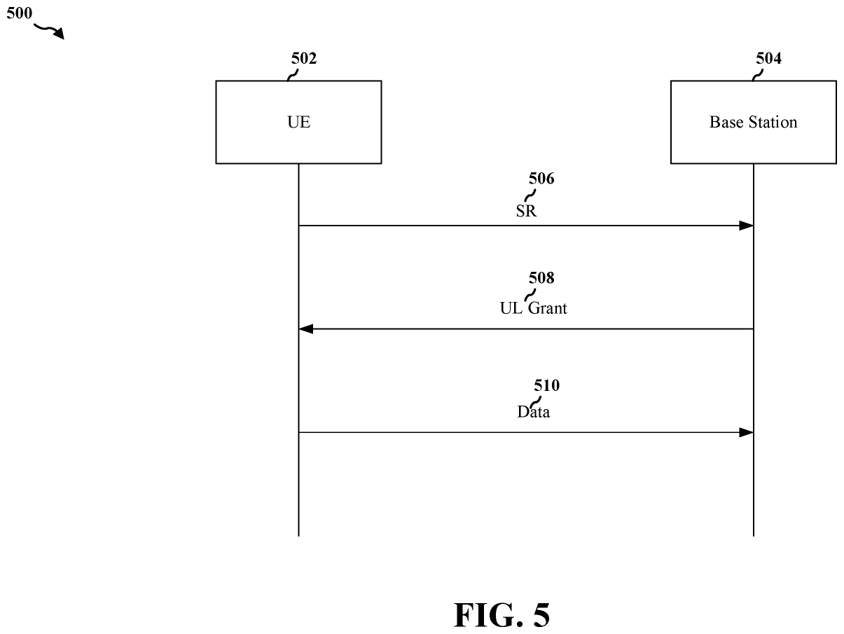

FIG. 5 illustrates an example 500 of a call flow between a UE 502 and a base station 504 in which the UE 502 transmits a SR 506 to the base station 504. The UE may transmit the SR to receive UL-SCH resources from the base station in response to, for example, a BSR procedure, a SCell beam failure recovery, and a consistent LBT failure recovery. After the UE transmits SR 506, the UE may trigger the prohibit timer for that SR. If the prohibit timer expires before the UE receives an UL grant 508 from the base station, the UE may retransmit the SR. The UE may continue in this manner for a maximum number of SR transmissions in the associated SR configuration. If the UE receives the UL grant in response to an SR such as illustrated in FIG. 5, the UE may proceed to transmit data 510 in the resources indicated in the UL grant.

As an alternative to receiving a dynamic grant in response to a SR, the UE may receive a configured grant from the base station, for instance, a configured grant Type 1 or a configured grant Type 2. A configured grant Type 1 is an uplink grant the base station provides to the UE via an RRC configuration. The UE may store this uplink grant as a configured uplink grant, and thus may transmit data to the base station in resources associated with that configured uplink grant. A configured grant Type 2 is an uplink grant the base station provides to the UE via PDCCH (or other layer 1 signaling). For instance, the base station may configure this uplink grant via an RRC configuration but activate or deactivate the uplink grant via DCI in PDCCH. The UE may store this configured uplink grant, and thus may transmit data to the base station in resources associated with that configured uplink grant, when the uplink grant is active. The UE may clear this configured uplink grant, and thus may not transmit data to the base station in resources associated with that configured uplink grant, when the uplink grant is inactive.

The base station may configure a configured grant Type 1 and configured grant Type 2 via an RRC configuration for a serving cell of the UE for each BWP. Moreover, multiple configurations may be simultaneously active in the same BWP. For configured grant Type 2, the base station may activate or deactivate a configured grant independently among the serving cells of the UE. The MAC entity of the UE may be configured with both configured grant Type 1 and configured grant Type 2 for a same BWP. The maximum number of configured grant configurations for each BWP is currently 12, although this maximum may be subject to change. The periodicity of a configured grant Type 1 or a configured grant Type 2 may depend on an applied SCS. For example, any of the following configured grant periodicities may be configured depending on the SCS, in number of symbols:
15 kHz: 2, 7, n*14, where n={1, 2, 4, 5, 8, 10, 16, 20, 32, 40, 64, 80, 128, 160, 320, 640}
30 kHz: 2, 7, n*14, where n={1, 2, 4, 5, 8, 10, 16, 20, 32, 40, 64, 80, 128, 160, 256, 320, 640, 1280}
60 kHz with normal CP 2, 7, n*14, where n={1, 2, 4, 5, 8, 10, 16, 20, 32, 40, 64, 80, 128, 160, 256, 320, 512, 640, 1280, 2560}
60 kHz with ECP: 2, 6, n*12, where n={1, 2, 4, 5, 8, 10, 16, 20, 32, 40, 64, 80, 128, 160, 256, 320, 512, 640, 1280, 2560}
120 kHz: 2, 7, n*14, where n={1, 2, 4, 5, 8, 10, 16, 20, 32, 40, 64, 80, 128, 160, 256, 320, 512, 640, 1024, 1280, 2560, 5120}

A UE may also receive BSR parameters from the base station via one or more RRC configurations which control the BSR and thus the triggering of an SR. At least one of these BSR parameters may also depend on whether a configured uplink grant is configured. For instance, the UE may receive a logical channel configuration from the base station including a logical channel SR mask (which controls SR triggering when a configured grant type 1 or type 2 is configured), and a SR delay timer application flag (which indicates whether to apply a delay timer for SR transmission for a logical channel if the delay timer is included in a BSR configuration, otherwise is set to false), and a BSR configuration from the base station including a SR delay timer (which delays transmission of the SR until timer expiration). The SR delay timer may be configured to be any of the following number of subframes, for example: 20, 40, 64, 128, 512, 1024, and 2560. The SR delay timer is distinct from the prohibit timer of an SR configuration (the latter of which prohibits transmission of a subsequent SR until timer expiration after a previous SR transmission). The prohibit timer may be configured to be any of the following number of milliseconds, for example: 1, 2, 4, 8, 16, 32, 64, 128.

Typically for uplink transmissions, a UE may receive from a base station an SR configuration or a configured grant (CG) PUSCH (CG-PUSCH) configuration, such as a configured grant type 1 or configured grant type 2. Each of these configurations may be associated with a set of occasions for unscheduled uplink transmissions by the UE to the base station. However, the UE typically may not utilize all of these occasions, and since the base station has not granted these occasions dynamically to the UE in response to a UE request, the base station generally may not ascertain which occasions the UE will actually use for an uplink transmission. As a result, the base station tends to actively and blindly monitor all these occasions whether or not used by the UE, leading to significant energy consumption at the base station. Since many of these occasions may end up being unused, the base station wastes significant energy monitoring many of these occasions. Moreover, since the number of occasions associated with SR or CG-PUSCH transmissions may be large (e.g., with a periodicity of at minimum every two symbols), energy efficiency is significantly degraded. Thus, it would be helpful to allow a base station to minimize blind monitoring of SR or CG-PUSCH transmission occasions to improve energy efficiency of the base station and achieve network energy savings.

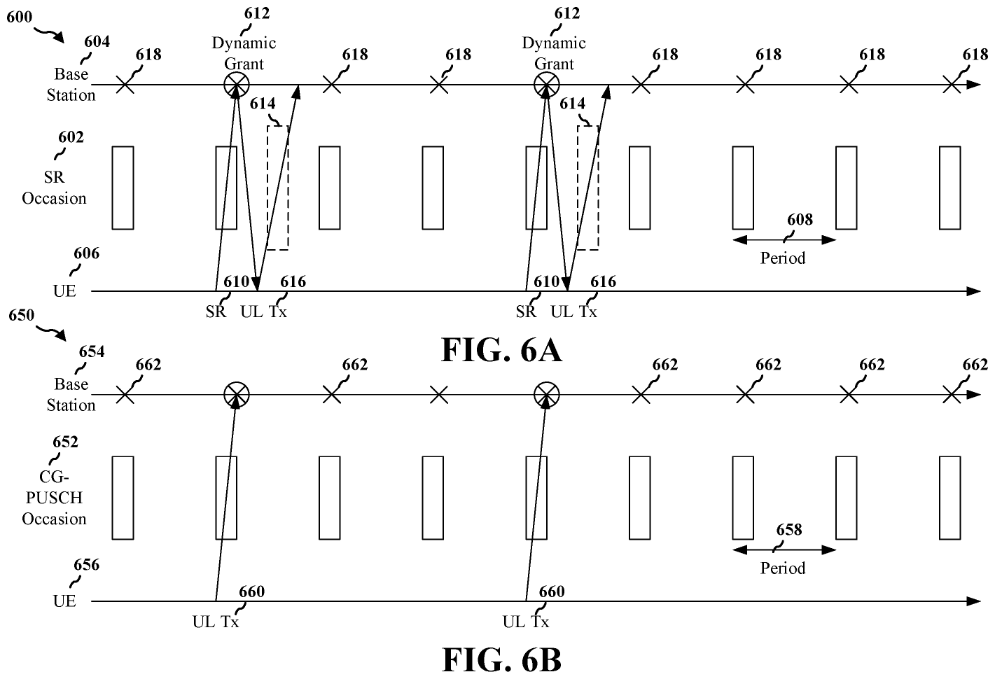

FIGS. 6A and 6B illustrate examples 600, 650 respectively of SR occasions 602 and CG-PUSCH occasions 652 which a base station 604, 654 may configure for a UE 606, 656. For instance, in the example of FIG. 6A, the base station 604 may provide a SR configuration and SR resource configuration for a logical channel which indicates the resources or SR occasions 602 in which the UE 606 may transmit a SR in response to a BSR for that logical channel, SCell beam failure recovery, or a consistent LBT failure recovery. The base station 604 may also provide a logical channel configuration and a BSR configuration indicating whether a logical channel SR mask is enabled (in which case SR occasions 602 would be masked and thus SR transmissions in those occasions prohibited) or whether a SR delay timer applies (in which case SR occasions 602 and thus transmissions would be delayed until the timer expires). Similarly, in the example of FIG. 6B, the base station 654 may provide a CG-PUSCH configuration, such as a configured grant Type 1 or a configured grant Type 2, which indicates the resources or CG-PUSCH occasions 652 in which the UE 656 may transmit uplink data (subject to activation of the CG-PUSCH occasions 652 in DCI if a configured grant Type 2 is configured). The SR resource configuration may configure SR occasions 602 to have a periodicity 608 (e.g., two symbols) in the example of FIG. 6A, and the configured grant configuration may configure CG-PUSCH occasions 652 to have a periodicity 658 (e.g., two symbols) in the example of FIG. 6B.

As illustrated in the example of FIG. 6A, the base station 604 may monitor for an SR 610 from the UE 606 in each of the SR occasions 602. If the base station 604 receives SR 610 in any of these occasions, the base station may transmit a dynamic grant 612 to the UE 606 configuring resources 614 for the UE 606 to apply for an uplink transmission 616. However, typically the UE 606 may transmit SR 610 in infrequent occasions such as illustrated in FIG. 6A. Thus, the base station 604 may waste energy monitoring many of the configured occasions since, as illustrated at monitor times 618, the base station may not receive an SR in these monitored occasions. Similarly, as illustrated in the example of FIG. 6B, the base station 654 may monitor for an uplink transmission 660 from the UE 656 in each of the CG-PUSCH occasions 652. However, typically the UE 656 may transmit uplink transmission 660 in infrequent occasions such as illustrated in FIG. 6B. Thus, the base station 654 may waste energy monitoring many of the configured occasions since, as illustrated at monitor times 662, the base station may not receive an uplink transmission in these monitored occasions.

One approach that may provide energy savings to the base station 604, 654 is if the base station were to configure infrequent SR or CG-PUSCH resources via its RRC configurations, for example, to have large periodicities. With large periodicities, the base station 604, 654 may reduce an amount of the monitor times 618, 662 such that the base station may perform monitoring in fewer occasions of SR occasions 602 or CG-PUSCH occasions 652, saving energy. However, this approach may significantly impact UE uplink latency, since its SRs 610 or uplink transmissions 616, 660 would consequently be delayed.

Another approach that may provide energy savings to the base station 604, 654 is if the base station were to dynamically activate or deactivate occasions for UE uplink transmissions via layer 1 signaling. For example, for configured grant type 2, the base station may transmit a DCI deactivating the CG-PUSCH occasions 652 until the base station later transmits another DCI re-activating the CG-PUSCH occasions 652. The fewer occasions of CG-PUSCH occasions 652 which would result from the deactivation would lead to the base station performing less monitoring, thereby saving energy. However, this deactivation and reactivation is typically limited to configured grant type 2, and therefore it would be helpful if such energy savings could be applied to SRs and configured grant type 1 as well as configured grant type 2. Additionally, the deactivation and reactivation for configured grant type 2 is a binary operation with limited flexibility, and therefore it would be helpful if more flexible options for deactivation and reactivation of SR occasions or CG-PUSCH occasions could be applied.

To provide more energy savings at the base station with flexibility, in one example, the base station may dynamically activate or deactivate SR configurations, and thus SR transmissions, via DCI, a MAC-CE, or other layer 1 (L1) or layer 2 (L2) signaling. For instance, after the base station configures an SR configuration for the UE via an RRC configuration, the base station may transmit a message via L1 or L2 signaling to the UE which activates or deactivates the SR configuration. For example, the message may include a bit which activates or deactivates an SR configuration for a logical channel depending on whether the bit is 0 or 1. In another example, after the base station configures an SR resource configuration for a UE via an RRC configuration, the base station may transmit a message via L1 or L2 signaling to the UE which activates or deactivates the SR resource configuration. For example, the message may include a bit which activates or deactivates an SR resource configuration for an SR configuration depending on whether the bit is 0 or 1. The message activating or deactivating a SR resource configuration may be the same message or a different message than a message activating or deactivating a SR configuration. Moreover, the base station may activate or deactivate multiple SR configurations in one or more messages, or multiple SR resource configurations in one or more messages.

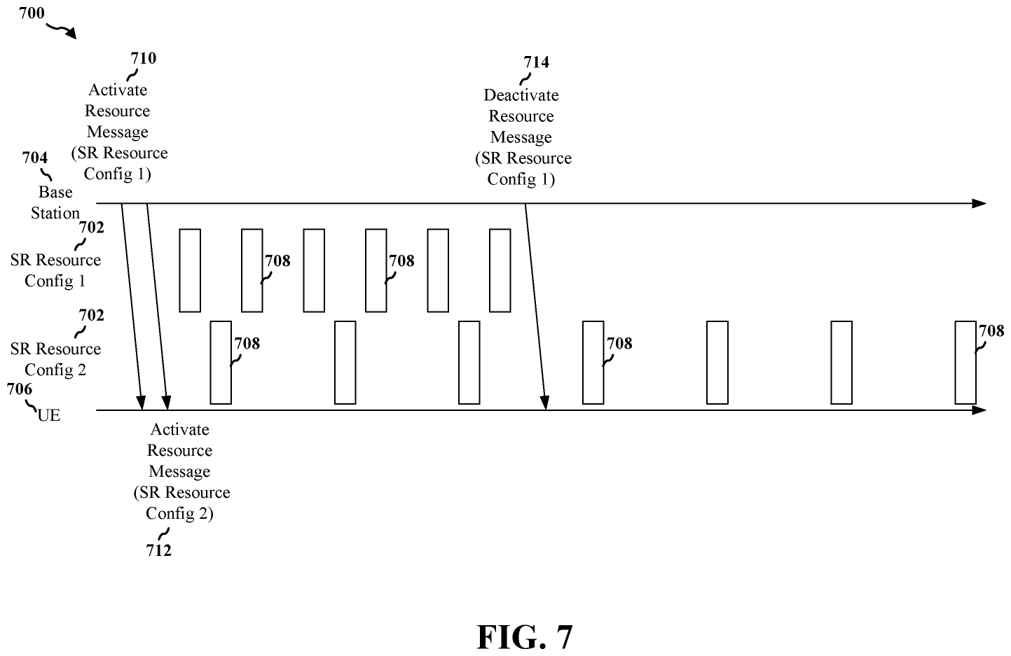

FIG. 7 illustrates an example 700 of SR resource configurations 702 which a base station 704 may configure for a UE 706. In the illustrated example, the base station configures two SR resource configurations indicating different periodicities or offsets for SR occasions 708, although the base station may configure a different number of SR resource configurations in other examples. Initially or by default, the SR resource configurations 702 and thus the SR occasions 708 may be deactivated, so the UE 706 initially does not transmit SR in the configured occasions. After the base station 704 provides an activate resource message 710 for SR resource configuration 1 and an activate resource message 712 for SR resource configuration 2, both of which indicate the associated SR resource configurations are active, the SR occasions 708 corresponding to the active SR resource configurations may be monitored for SR transmissions such as illustrated in FIG. 7. The providing of multiple activate resource messages here is merely an example; in other examples, a single message activating both SR resource configurations or activating only one SR resource configuration may be provided. Alternatively in other examples, rather than being deactivated by default, the SR resource configurations 702 and thus the SR occasions 708 may be activated by default, in which case no activate resource messages would be provided initially. While the SR occasions 708 are active, the UE may transmit SR in each of the SR occasions, and the base station may monitor each of the occasions for an SR transmission from a UE. Later on in this example, the base station 704 may provide a deactivate resource message 714 for SR resource configuration 1, indicating the associated SR resource occasion is inactive, and thus the SR occasions 708 corresponding to SR resource configuration 1 may no longer be monitored for SR transmissions. As a result, only the SR occasions 708 corresponding to the remaining active SR resource configuration may be applied and monitored for SR transmissions such as illustrated in FIG. 7, providing energy savings at the base station.

The base station may also or alternatively configure parameters associated with an SR configuration or SR resource configuration in message(s) or L1/L2 signaling for activating or deactivating SR transmissions. In one example, the message may specify a duration for activation or deactivation of SR transmissions, which duration may be expressed in units of time or in number of SR occasions. For instance, the message may indicate that the UE may transmit SR, or refrain from transmitting any SR, for a certain period of time or given number of SR occasions. Thus, as an alternative to the example of FIG. 7, activate resource message 710 (or a different message) may indicate, for example, that the active duration spans a maximum of six SR occasions, after which the SR resource configuration 1 may be switched to inactive (without sending deactivate resource message 714). In another example, the message may modify a prohibit timer associated with an SR configuration. For instance, the message may start, restart, or stop the prohibit timer associated with an SR configuration in order to control the timing of subsequent SR transmissions. Thus, as an alternative to the example of FIG. 7, activate resource message 710 (or a different message) may indicate to periodically stop and restart the prohibit timer after each SR occasion 708 to effectively increase the SR occasion periodicity to match that of SR resource configuration 2, and thus deactivate any SR transmissions that otherwise would have been transmitted at the original SR occasion periodicity.

In a further example, the message may modify logical channel parameters associated with an SR configuration. For instance, the message may enable, disable, or delay the triggering of an SR transmission upon data availability for a logical channel, for example, by toggling the logical channel SR mask or the SR delay timer application flag, or by starting, restarting, or stopping the SR delay timer for that SR configuration. Thus, as an alternative to the example of FIG. 7, activate resource message 710 (or a different message) may indicate to start the SR delay timer such that the initial SR occasion for SR resource configuration 1 is aligned in time to the initial SR configuration for SR resource configuration 2, thereby deactivating any SR occasions of SR resource configuration 1 that otherwise would have preceded those of SR resource configuration 2 in the original configuration.

In the aforementioned examples, the activation and deactivation may be specific to one configuration or transmission, or the activation and deactivation may apply to a multitude of SR configurations or transmissions. For instance, as illustrated in the example of FIG. 7, the base station 704 may send one message specifically activating or deactivating SR resource configuration 1, namely activate resource message 710, and another message specifically activating or deactivating SR resource configuration 2, namely activate resource message 712. However, in an alternative example, the activate resource message 710 or 712 may activate or deactivate both SR resource configurations 1 and 2. Similarly, in the aforementioned examples, the activation and deactivation may be specific to one UE, or the activation and deactivation may be multicast or broadcast signaled to a cell including multiple UEs. For instance, as an alternative to the example of FIG. 7, the deactivate resource message 714 may be broadcast to multiple UEs including UE 706 informing these UEs that the base station 704 will not monitor SR resource configuration 1 for SR transmissions from any associated UE (not only UE 706).

Generally, for a logical channel, for SCell beam failure recovery, or for consistent LBT failure recovery, the base station may configure at most one PUCCH resource for SR for each BWP. As a result, if the base station were to deactivate the PUCCH resource for an SR for a given BWP according to any of the aforementioned examples, the UE may not have any valid resource to transmit SR on that same BWP during the deactivation. Accordingly, the base station may relax this limitation by configuring multiple PUCCH resources for the SR on the given BWP. For instance, the base station may allow the UE to transmit SR in multiple PUCCH resources on a BWP in response to data availability for a logical channel associated with that SR, SCell beam failure recovery, or consistent LBT failure recovery. Thus, even if the base station deactivates one PUCCH resource for a SR, the SR may have at least one other PUCCH resource available for the UE to apply.

In other examples, the base station may not activate or deactivate an SR occasion, but instead reconfigure that SR occasion using L1/L2 signaling. For instance, when the base station configures an SR resource configuration via an RRC configuration, the base station may modify the parameters of the SR resource configuration dynamically in DCI, MAC-CE, or using some other L1/L2 signaling. Such parameters may include, for example, a periodicity and an offset of the SR occasion. Thus, as an alternative to the example of FIG. 7, the activate resource message 710 may modify the periodicity originally configured in SR resource configuration 1 to match that of SR resource configuration 2, thereby reconfiguring SR resource configuration 1 to result in fewer SR occasions and thus greater base station energy saving.

In any of the foregoing examples, the base station may indicate a time upon which activation, deactivation, or reconfiguration of an SR configuration, SR resource configuration, logical channel configuration, BSR configuration, or other SR-associated configuration takes effect via L1/L2 signaling. For instance, the base station may provide a DCI, MAC-CE, or other L1/L2 signaling which not only informs the UE as to an activation, deactivation, or reconfiguration of SR occasions, but also as to a time delay until when the activation, deactivation, or reconfiguration begins. Thus, as an alternative to the example of FIG. 7, the activate resource message 710 may, in addition to activating the SR occasions 708 for SR resource configuration 1, indicate the activation will occur a number of symbols, slots, subframes, SR occasions, or other unit of time after transmission of the activate resource message 710, thereby delaying the initial SR occasion from occurring until after this unit of time has passed and further saving base station energy from reduced monitoring.

In any of the foregoing examples, the base station may dynamically activate, deactivate, or reconfigure an SR configuration or SR-associated configuration based on one or more UE capabilities. For instance, the UE may indicate in a capability information message to the base station that the UE is capable of activating, deactivating, or reconfiguring an SR configuration, and the base station may configure and transmit a DCI, MAC-CE, or other L1/L2 signaling from the base station activating, deactivating, or reconfiguring an SR configuration according to any of the aforementioned examples in response to this indicated UE capability. Thus, as an alternative to the example of FIG. 7, the base station 704 may transmit activate resource message 710 to the UE 706 to activate SR occasions 708 in SR resource configuration 1 in response to the UE 706 previously indicating a capability of handling such message from the base station.

While the foregoing examples specifically refer to SRs and associated configurations, it should be understood that the examples are not limited to SRs. For instance, the foregoing concepts can similarly be applied to configured grant type 1 and configured grant type 2. For example, the base station may provide one or more messages to the UE, via L1/L2 signaling, which activates, deactivates, or reconfigures CG-PUSCH occasions associated with a configured grant configuration that is provided via an RRC configuration to the UE. The messages may activate, deactivate, or reconfigure CG-PUSCH occasions in a similar manner to that previously described for SR occasions, for example, by modifying similar parameters for configured grants.

In addition to or as an alternative to dynamically activating SR or configured grant configurations via L1/L2 signaling, the base station may provide a semi-static discontinuous transmission (DTX) configuration to the UE to provide similar energy savings at the base station. In one example, the DTX configuration may be a UE DTX configuration, based on which configuration the UE periodically operates in a sleep mode to save transmission power when no UE transmissions are expected during periodic intervals. The base station may refrain from monitoring for UE transmissions during these periodic intervals to achieve network energy savings. In another example, the DTX configuration may be a cell DRX configuration, based on which configuration the base station periodically operates in a sleep mode to save reception power when no UE transmissions are expected during periodic intervals. The base station may stop supplying power to its radio frequency (RF) chains or RF components such as its antennas, transmitter(s), receiver(s), or transceiver(s) during these periodic intervals to similarly achieve network energy savings. In response to receiving the DTX configuration, the UE may transmit in valid resources falling within activity intervals indicated in the DTX configuration while discontinuing transmissions outside these intervals. For instance, the UE may transmit SRs, uplink data in CG-PUSCH occasions, and other uplink data during an active or on duration while refraining from transmitting such information during an inactive or off duration.

While a DTX cycle is in the off duration, the base station may not monitor SR occasions or CG-PUSCH occasions, thereby saving energy. While a DTX cycle is in the on duration, the base station may apply any of the foregoing example concepts of activation, deactivation, and reconfiguration irrespective of the DTX configuration to save additional power at the base station. For example, the base station may apply any of the concepts described with respect to the foregoing examples of FIG. 7 to activate, deactivate, or reconfigure SRs, CG-PUSCH, or other uplink transmissions during on durations of DTX cycles. Alternatively, while the DTX cycle is in the on duration, the base station may maintain SR or CG-PUSCH occasions without performing any deactivation or reconfiguration, since the DTX configuration alone may serve to improve base station energy savings. Moreover, the base station may activate, deactivate, or reconfigure SR configurations, CG-PUSCH configurations, or other uplink configurations with respect to the DTX configuration. For example, the base station may semi-statically or dynamically indicate whether SRs in general, SRs associated with a specific SR configuration, CG-PUSCH transmissions in general, CG-PUSCH transmissions associated with a specific CG configuration, random access channel (RACH) transmissions, or other uplink transmissions may be deactivated from DTX and thus may be transmitted during off durations of DTX cycles, or activated for DTX and thus may not be transmitted during off durations of DTX cycles.

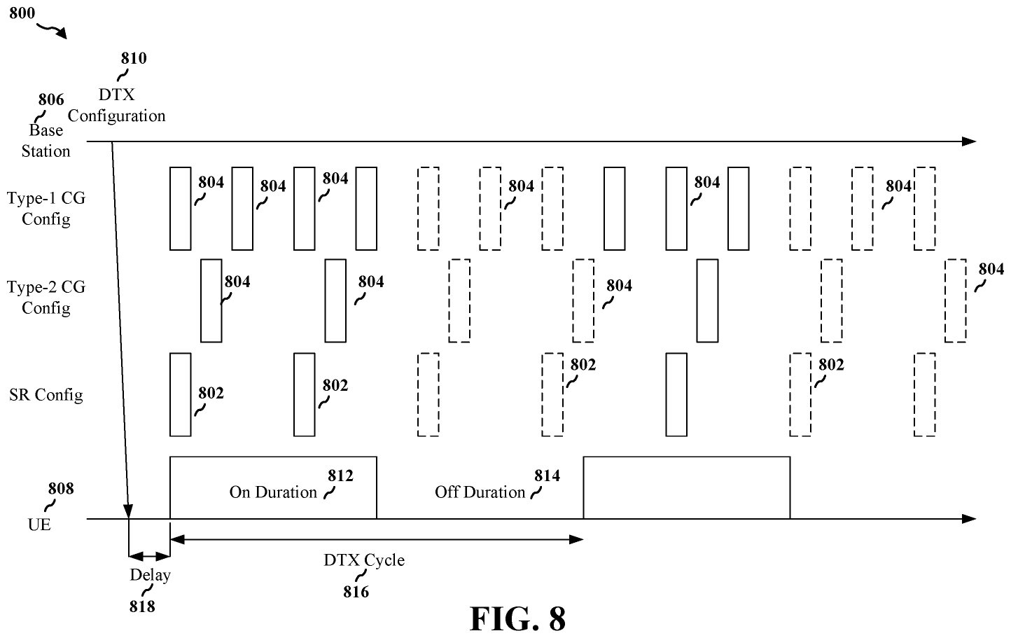

FIG. 8 illustrates an example 800 of SR occasions 802 and CG-PUSCH occasions 804 (for one configured grant type 1 and another configured grant type 2) that a base station 806 may configure for a UE 808 via an SR configuration and configured grant configurations respectively. In this example, the base station 806 also provides a DTX configuration 810 to the UE 808 which specifies on duration 812 and off duration 814 of a DTX cycle 816, and a delay 818 prior to the beginning of the on duration 812. During the on duration 812, the UE may transmit data in SR occasions 802 and CG-PUSCH occasions 804 subject to any activation, deactivation, and reconfiguration of these occasions or configurations according to any of the foregoing examples of FIG. 7 to save base station energy. The UE may also transmit other data than SRs or CG-PUSCH data during the on duration 812, such as RACH signals or other uplink data. While the example of FIG. 8 illustrates a single DTX configuration associated with different uplink transmission configurations, such as SR configurations, type-1 CG configurations, and type-2 CG configurations, in other examples, different DTX configurations having aligned DTX cycles may be respectively associated with different uplink transmission configurations. Moreover, a UE DRX configuration (not shown) may also have aligned DRX cycles with DTX cycles 816.

Generally, during the off duration 814, the UE may not transmit data in these occasions, and therefore the base station may not monitor any of the SR occasions 802 or CG-PUSCH occasions 804 that fall within the off duration 814. The occasions which the base station may refrain from monitoring are illustrated in FIG. 8 as masked occasions in dashed lines. As a result, further energy savings at the base station may be achieved through application of DTX. However, this behavior of the UE and base station may change semi-statically or dynamically subject to any activation, deactivation, or reconfiguration of these occasions or configurations with respect to DTX configuration 810, or subject to any activation, deactivation, or reconfiguration of the DTX configuration 810 itself. For example, the occasions of one or more rows in FIG. 8, such as the occasions corresponding to the SR configuration and type 1 CG configuration specifically, may instead be replaced with solid lines in the Figure (not masked) and thus be subject to base station monitoring even during off durations 814, when these particular configurations are semi-statically or dynamically deactivated for DTX. Similarly, the occasions of every row in FIG. 8, or uplink transmissions in general, may be instead replaced with solid lines in the Figure (not masked) and thus subject to base station monitoring even during off durations 814, when the DTX configuration 810 itself is semi-statically or dynamically deactivated. Thus, if the base station provides an RRC configuration, a MAC-CE, or a DCI deactivating DTX configuration 810 in general, or deactivating specific uplink transmissions (in general or per configuration) with respect to one or more DTX configurations 810, the UE and base station may disregard whether or not the occasions 802, 804 associated with these deactivated uplink transmissions fall within off durations 814 when respectively performing uplink transmission and monitoring. On the other hand, if the base station provides an RRC configuration, a MAC-CE, or a DCI activating DTX configuration 810 in general, or activating specific uplink transmissions (in general or per configuration) with respect to one or more DTX configurations 810, the UE and base station may refrain from respectively performing uplink transmission and monitoring in the occasions 802, 804 associated with these activated uplink transmissions within off durations 814.

In one example, the DTX configuration 810 which the base station provides to the UE may include at least one of the following parameters: a time instant (e.g., a subframe or other DTX start offset) where the DTX cycle 816 begins, on duration 812 within which UE 808 may transmit uplink data on valid resources, off duration 814 within which resources for uplink transmissions by UE 808 are masked, delay 818 (e.g., a DTX slot offset) before starting the on duration 812 within the DTX cycle 816, and a duration or periodicity of the DTX cycle 816. The DTX configuration 810 may also include a plurality of DTX cycles, such as a long DTX cycle and a short DTX cycle. For instance, as an alternative to the example of FIG. 8, the DTX configuration 810 may configure a long DTX cycle corresponding to DTX cycle 816 (having a duration equal to that of DTX cycle 816 illustrated in FIG. 8), and a short DTX cycle smaller than the long DTX cycle which activates in response to activity within the on duration 812 of the long DTX cycle. The short DTX cycle may continue for a configured period of time, after which time if no activity occurs within the on duration, the DTX cycle may revert back to the long DTX cycle.

In various examples, the DTX configuration may be associated with one or more types of transmissions of a UE. In one example, the DTX configuration may be associated with SR transmissions by a UE. For instance, referring to FIG. 8, the DTX configuration 810 may configure the UE 808 to transmit any SR for any SR configuration in any SR occasion within the on duration 812 but not within the off duration 814, subject to semi-static or dynamic DTX activation or deactivation of SR transmissions in general. In another example, the DTX configuration may be associated with SR transmissions pertaining to an SR configuration or SR resource configuration of a UE. For instance, as an alternative to the example of FIG. 8, the DTX configuration 810 may configure the UE to transmit SRs for at least one specific SR configuration or SR resource configuration (but not in other unspecified SR configurations or SR resource configurations of the UE) in an associated SR occasion within the on duration 812 but not within the off duration 814, subject to semi-static or dynamic DTX activation or deactivation of the specific SR or SR resource configuration. In another example, the DTX configuration may be associated with CG-PUSCH transmissions by a UE. For instance, referring to FIG. 8, the DTX configuration 810 may configure the UE 808 to transmit uplink data in response to a configured grant for any configured grant configuration in any CG-PUSCH occasion within the on duration 812 but not within the off duration 814, subject to semi-static or dynamic DTX activation or deactivation of CG-PUSCH transmissions in general. In another example, the DTX configuration may be associated with CG-PUSCH transmissions pertaining to a configured grant configuration of a UE. For instance, as an alternative to the example of FIG. 8, the DTX configuration 810 may configure the UE 808 to transmit uplink data in response to a configured grant for at least one specific configured grant configuration (but not for other unspecified configured grant configurations of the UE) in an associated CG-PUSCH occasion within the on duration 812 but not within the off duration 814, subject to semi-static or dynamic DTX activation or deactivation of the specific CG configuration. The specific configured grant configuration applicable for DTX may be associated with, for example, any configured grant type 1, a specific configured grant type 1 (but not other unspecified configured grant type 1s), any configured grant type 2, or a specific configured grant type 2 (but not other unspecified configured grant type 2s), or a combination of any of the foregoing.

In another example, the DTX configuration may be associated with RACH transmissions by a UE. For instance, as an alternative to the example of FIG. 8, the DTX configuration 810 may configure the UE 808 to transmit RACH signals within the on duration 812 but not within the off duration 814, subject to semi-static or dynamic DTX activation or deactivation of RACH transmissions. In a further example, the DTX configuration may be associated with general uplink transmissions by the UE. For instance, as an alternative to the example of FIG. 8, the DTX configuration 810 may configure the UE 808 to transmit any uplink data (e.g., PUCCH data or PUSCH data) within the on duration 812 but not within the off duration 814, subject to semi-static or dynamic DTX activation or deactivation of uplink transmissions in general or the DTX configuration itself. In a further example, the DTX configuration may be associated with a combination of any of the foregoing transmissions (e.g., SR, CG-PUSCH, RACH, general UL, etc.). In any of the foregoing examples, the DTX configuration may be a dedicated RRC configuration for DTX which includes parameters for SRs, configured grants, etc., or the DTX configuration may be a sub-configuration or information element for DTX within another configuration for an associated transmission (e.g., a DTX information element within a SR configuration, SR resource configuration, configured grant configuration, etc.).

In one example, the DTX configuration may be associated with a communication resource for an uplink transmission of the UE. The communication resource may be, for example, a BWP, one or more serving cells, a serving cell group, a frequency range, or a combination of the foregoing. For instance, as an alternative to the example of FIG. 8, the DTX configuration 810 may configure the UE 808 to transmit SRs, CG-PUSCH data, RACH signals, PUCCH data, PUSCH data, or other uplink data within the on duration 812 but not the off duration 814 in at least one specific BWP (but not for other unspecified BWPs), in one or more specific serving cells (but not other unspecified serving cells), in at least one specific serving cell group (but not other unspecified serving cell groups), in at least one specific frequency range (but not other unspecified frequency ranges), or a combination of any of the foregoing. In any of the foregoing examples, the DTX configuration may be a dedicated RRC configuration for DTX which includes parameters for BWPs, serving cells, serving cell groups, frequency ranges, etc., or the DTX configuration may be a sub-configuration or information element for DTX within another configuration for an associated transmission (e.g., a DTX information element within a BWP configuration, cell configuration, frequency range configuration, etc.).

In some examples, the UE may apply multiple DTX configurations, or a DTX configuration and a DRX configuration. For example, the base station may configure the UE to apply one DTX cycle with one periodicity or other parameter for SRs and another DTX cycle with a different periodicity or other parameter for configured grants, or a DTX cycle with one periodicity or other parameter for uplink data and a DRX cycle with a different periodicity or other parameter for downlink data. In the former case (two DTXs), the base station may minimize the active time of the UE by aligning the DTX configurations or DTX cycles. For instance, as an alternative to the example of FIG. 8, the base station 806 may configure multiple DTX configurations 810, including one DTX configuration for the SR occasions 802 and one DTX configuration for the CG-PUSCH occasions 804, such that the on durations 812 of the DTX cycles 816 in the respective DTX configurations are aligned. Similarly, in the latter case (DTX and DRX), the base station may minimize active time of the UE by aligning the DTX configuration and DRX configuration of the UE. For instance, as an alternative to the example of FIG. 8, the base station 806 may also configure a DRX configuration for the UE 808 along with the DTX configuration 810 such that the on duration 812 of the DTX cycle 816 in the DTX configurations is aligned with the on duration of the DRX cycle in the DRX configuration.

In another example, the base station may configure time extensions to the on duration of DTX and DRX cycles depending on a network traffic pattern. For instance, the base station may define an extension for the active time of a DTX cycle based on occurrence of downlink or uplink activity during the active time of the DTX cycle. This activity may include, but is not limited to, reception of PDSCH or PDCCH data, transmission of PUSCH or PUCCH data, and reception of HARQ feedback triggering retransmission (e.g., a NACK resulting in a downlink or uplink grant without toggling a new data indicator (NDI)). For example, as an alternative to the example of FIG. 8, the base station 806 may configure the DTX configuration 810 to include a time extension parameter, such as an inactivity timer, which indicates how long to extend the length of on duration 812 in response to UE transmission or reception of data or HARQ feedback during the on duration 812. Similarly, the base station may define an extension for the active time of a DTX cycle based on occurrence of downlink or uplink activity during an active time of a DRX cycle of the UE. For example, as an alternative to the example of FIG. 8, the base station 806 may configure a DRX configuration for the UE 808 with its own DRX on duration and off duration in addition to the DTX configuration 810. The base station 806 may configure the DTX configuration 810 to include a time extension parameter, such as an inactivity timer, which indicates how long to extend the length of on duration 812 of DTX cycle 816 in response to UE transmission or reception of data or HARQ feedback during the DRX on duration.

In one example, similar to SR configurations, SR resource configurations, and configured grant configurations, the base station may activate or deactivate a DTX configuration dynamically via L1 or L2 signaling. For instance, the base station 806 may transmit a DCI, MAC-CE, or other L1 or L2 message indicating to UE 808 that DTX configuration 810 is active, in response to which the UE and base station may apply the DTX cycle 816. Later on, the base station may transmit a similar message indicating to UE 808 that DTX configuration 810 is inactive, in response to which the UE may no longer apply DTX cycle 816. The base station may activate or deactivate DTX configurations in a similar manner as that of SR configurations, SR resource configurations, or configured grant configurations as indicated in the foregoing examples. The base station may activate or deactivate DTX configurations similarly in a semi-static manner via RRC or layer 3 signaling. The base station may alternatively or additionally activate or deactivate SR configurations, SR resource configurations, configured grant configurations, or other uplink transmission configurations with respect to DTX configuration 810 in a similar manner semi-statically or dynamically.

In one example, the base station may apply L1 or L2 signaling to interrupt or cancel a first active time indicated by a DTX configuration. For instance, the base station may transmit a DCI, MAC-CE, or other L1 or L2 message which informs the UE to stop applying DTX during an on duration of an initial DTX cycle. For example, as an alternative to the example of FIG. 8, the base station 806 may transmit a DCI, MAC-CE, or other L1 or L2 message indicating to UE 808 to not apply at least a portion of the on duration 812 during the initially configured DTX cycle, and therefore not to transmit any uplink data during this portion or duration, until the next DTX cycle.

In one example, the base station may reconfigure parameters of a DTX configuration via L1 or L2 signaling. For instance, the base station may transmit a DCI, MAC-CE, or other L1 or L2 message which modifies at least one of a DTX start offset, on duration, off duration, delay, periodicity, or other parameter of a DTX configuration. Thus, as an alternative to the example of FIG. 8, the base station 806 may transmit a DCI, MAC-CE, or other L1 or L2 message reconfiguring the delay 818 to be longer or shorter than illustrated, the on duration 812 or off duration 814 to be longer or shorter than illustrated, to have a different periodicity for DTX cycle 816, or to include some other reconfiguration.

In one example, the base station may define one or more UE capabilities for support of one or more DTX configurations. For instance, the base station may provide a DTX configuration to the UE in response to identifying from a capability information message from the UE that the UE is capable of applying DTX. For example, as an alternative to the example of FIG. 8, the UE 808 may initially transmit a capability information message to the base station 806 indicating the UE is capable of supporting DTX in general, DTX for SR configurations in general or for specific SR configurations, DTX for configured grant configurations in general or for specific configured grant configurations, DTX for RACH signals, DTX for general uplink signals, DTX for specific BWPs, DTX for specific serving cells, DTX for specific serving cell groups, DTX for specific frequency ranges, or the like through one or more UE capabilities. In response to receiving this capability information message and determining the UE is capable of DTX in general for example, the base station 806 may configure DTX configuration 810 and provide the DTX configuration to the UE 808 accordingly.

In another example, the base station may indicate at least one parameter of a DTX configuration via a system information block (SIB) or multi-cast signaling. For instance, the base station may indicate at least one of a DTX start offset, on duration, off duration, delay, periodicity, or other parameter of a DTX configuration in an SIB broadcast to UEs in a serving cell, or in a multi-cast or groupcast message to certain UEs. Thus, as an alternative to the example of FIG. 8, the base station 806 may initially inform the UE 808 of at least one parameter of the DTX configuration 810, for example delay 818, on duration 812, or off duration 814, via a SIB or multi-cast message to the UE 808 and other UEs.

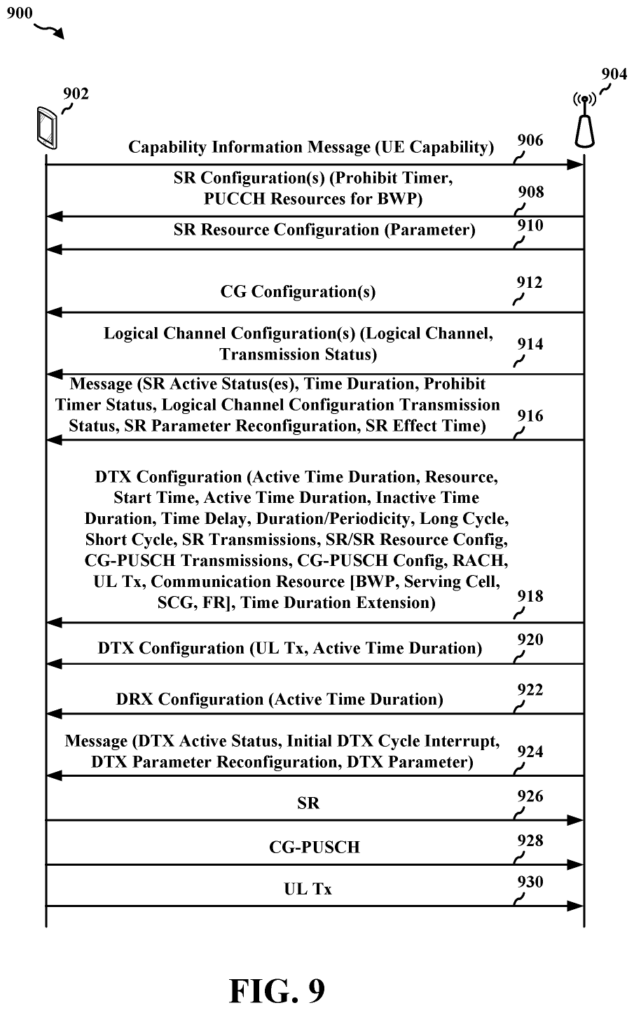

FIG. 9 illustrates an example 900 of a call flow diagram between a UE 902 and a base station 904. Initially, the UE 902 may transmit a capability information message 906 indicating a UE capability supporting activation, deactivation, or reconfiguration of SR configurations, configured grant configurations, DTX configurations, DRX configurations, or other configurations, or supporting the activation, deactivation, or reconfiguration of the parameters of such configurations. After receiving the capability information message 906, the base station 904 may transmit one or more SR configurations 908 and an SR resource configuration 910 to the UE 902. The SR configuration(s) 908 may include multiple parameters, including at least a prohibit timer and a maximum number of SR transmissions. The SR configuration(s) 908 or SR resource configuration 910 may also be associated with PUCCH resources for a BWP. Moreover, the base station 904 may transmit one or more configured grant configuration(s) 912 to the UE 902. The configured grant configuration(s) 912 may be for configured grant type 1, configured grant type 2, or both. The base station 904 may also transmit one or more logical channel configurations 914 to the UE 902. The logical channel configuration(s) 914 may indicate a logical channel associated with a respective SR configuration, and a transmission status of a respective SR indicating whether the SR is enabled, disabled, or delayed.

The base station 904 may subsequently transmit a message 916 to the UE 902 which may activate, deactivate, or reconfigure any of the foregoing configurations or the parameters in the configurations, irrespective of or independently of DTX configurations. The message 916 may be, for example, a DCI or MAC-CE dynamically activating, deactivating, or reconfiguring an SR configuration, a CG-PUSCH configuration, or other uplink transmission configuration such as described with respect to FIG. 7. Alternatively, the message 916 may be an RRC configuration semi-statically activating, deactivating, or reconfiguring an SR configuration, a CG-PUSCH configuration, or other uplink transmission configuration such as described with respect to FIG. 7. In one example, the message 916 may indicate one or more active statuses of respective SR configurations which indicate whether the respective SR configurations are active or inactive. In another example, the message 916 may indicate a time duration for the active status of the SR configuration. In another example, the message 916 may modify a timer status of the prohibit timer in a respective SR configuration. In another example, the message 916 may modify the transmission status of a respective logical channel configuration. In another example, the message 916 may reconfigure one or more parameters in a respective SR configuration or SR resource configuration. In another example, the message 916 may indicate an effect time of a respective SR configuration which indicates when the active status or a reconfiguration of the respective SR configuration takes effect. In any of the foregoing examples, the message 916 may activate, deactivate, or reconfigure respective SR configurations or SR resource configurations based on UE capability. In other examples, the message 916 may indicate, modify, or reconfigure similar parameters to any of the foregoing in configured grant configurations, also in some cases based on UE capability.

The base station 904 may also transmit a DTX configuration 918 to the UE 902. The DTX configuration 918 may be transmitted in a same message as, or in a different message than, a SR configuration, CG configuration, or other UE transmission configuration. In one example, the DTX configuration 918 may indicate an active time duration for a UE transmission such as an SR or CG-PUSCH and a resource for the UE transmission in UE DTX or cell DRX. In another example, the DTX configuration 918 may indicate at least one of a start time for a DTX cycle, an active time duration during the DTX cycle, an inactive time duration during the DTX cycle, a time delay prior to the start time for the DTX cycle, or a time duration or periodicity of the DTX cycle. In one example, the DTX configuration 918 may indicate a plurality of DTX cycles such as a long DTX cycle and a short DTX cycle. In one example, the DTX configuration 918 may be associated with at least one of SR transmissions of the UE 902, SR transmissions associated with an SR configuration or SR resource configuration of the UE 902, CG-PUSCH transmissions of the UE 902, RACH transmissions of the UE 902, uplink transmissions (in general) of the UE 902, or a combination of any of the foregoing. In one example, the DTX configuration 918 may be associated with uplink transmissions of the UE in a communication resource including at least one of a BWP, one or more serving cells, a serving cell group, a frequency range, or a combination of any of the foregoing. In one example, the DTX configuration 918 may indicate a time extension of an active time duration of a DTX cycle, and the time extension may be triggered at the UE in response to uplink or downlink activity during the active time duration.

In one example, the base station 904 may transmit another DTX configuration 920 to the UE 902. The DTX configuration 920 may indicate the same parameters (albeit different values) as DTX configuration 918 In one example, the DTX configuration 920 may be associated with uplink transmissions of the UE 902 and indicate an active time duration for UE DTX or cell DRX, and the base station 904 may configure the active time durations of the DTX configurations 918, 920 to be aligned.

In one example, the base station 904 may transmit a DRX configuration 922 to the UE 902. The DRX configuration 922 may include at least one of a DRX start offset, a DRX slot offset, a DRX active time duration or on duration, a DRX inactivity timer, and other parameters. In one example, the DRX configuration 922 may indicate a DRX active time duration for UE DRX, and the base station 904 may configure the active time duration of the DTX configuration 918 to be aligned with the DRX active time duration of the DRX configuration 922. In one example, the DRX configuration 922 may indicate a DRX active time duration, the DTX configuration 918 may indicate a time extension of an active time duration of a DTX cycle, and the time extension may be triggered in response to uplink or downlink activity during the DRX active time duration.

In various examples, the base station 904 may transmit a message 924 to UE 902. The message 924 may be associated with the DTX configuration 918. In one example, the message 924 may be a semi-static indication (such as an RRC configuration) or a dynamic indication (such as a DCI or MAC-CE) of an active status for a DTX configuration or for general UE transmissions with respect to a DTX configuration such as described with respect to FIG. 8. For instance, the message 924 may indicate a DTX active status of DTX configuration(s) 918, 920, which indicates whether DTX configuration(s) 918, 920 are active or inactive. In some examples, the message 924 may be a semi-static indication or a dynamic indication of an active status for specific UE transmissions or for specific uplink transmission configurations with respect to a DTX configuration such as also described with respect to FIG. 8. For instance, the message 924 may indicate an active status of an SR configuration, SR resource configuration, CG configuration, logical channel configuration, RACH configuration, or other UE transmission configuration with respect to one or more DTX configurations 918, 920. In one example, the DTX configuration 918 may indicate a plurality of DTX cycles, and the message 924 may interrupt or cancel an initial DTX cycle of the plurality of DTX cycles. In one example, the DTX configuration 918 may include a parameter for a UE transmission, and the message 924 may reconfigure the parameter. In one example, the message 924 may activate, deactivate, or reconfigure DTX configuration 918 based on a UE capability. In one example, the message 924 may indicate a parameter associated with the DTX configuration, and the message 924 may be a SIB or a multi-cast message for a plurality of UEs including UE 902.

In response to receiving the foregoing configuration(s) and message(s), the UE 902 may transmit an SR 926, a CG-PUSCH 928, or an uplink transmission 930 (e.g., a RACH signal, PUCCH data, PUSCH data, or other uplink data) accordingly.

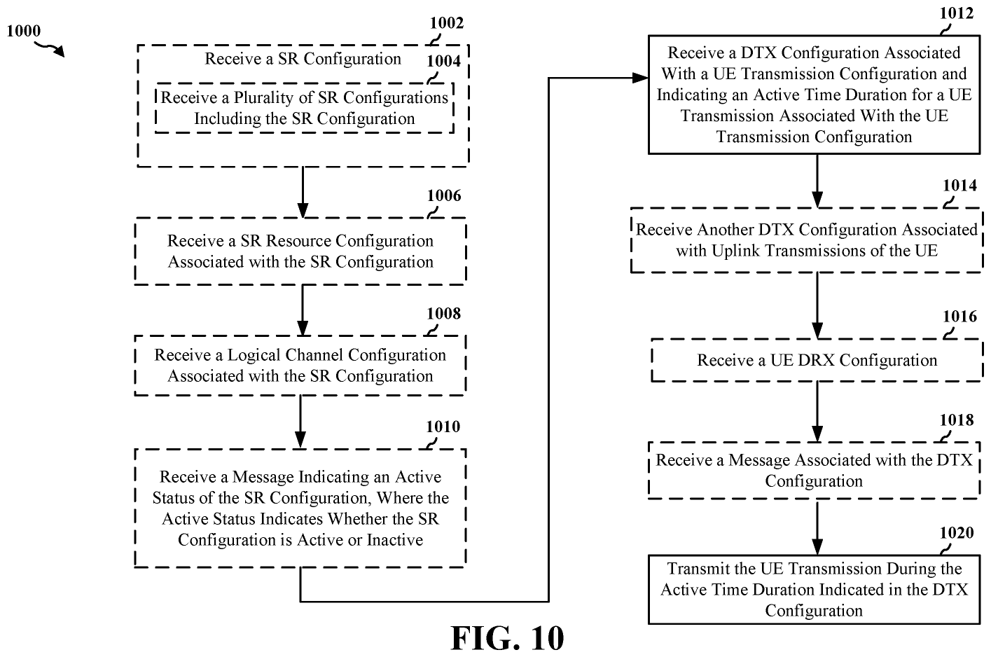

FIG. 10 is a flowchart 1000 of a method of wireless communication. The method may be performed by a UE (e.g., the UE 104, 350, 502, 606, 656, 706, 808, 902; the apparatus 1202). Optional aspects are illustrated in dashed lines. The method allows a UE to transmit an SR or other uplink transmission to a network entity such as a base station in UE DTX or cell DRX, subject to a message indication of dynamic activation, deactivation, or reconfiguration of the DTX configuration, SR configuration, or other uplink transmission configuration, in order to provide energy savings at the base station.

At 1002, the UE may receive a SR configuration associated with an SR. For example, 1002 may be performed by SR configuration component 1240. For instance, at 1004, the UE may receive a plurality of SR configurations including the SR configuration. For example, 1004 may be performed by SR configuration component 1240. For instance, referring to the aforementioned Figures, the UE 902 may receive one or more SR configuration(s) 908 from base station 904.

At 1006, the UE may receive a SR resource configuration associated with the SR configuration. For example, 1006 may be performed by SR resource configuration component 1242. For instance, referring to the aforementioned Figures, the UE 902 may receive SR resource configuration 910 from base station 904, which configuration may correspond in some examples to SR resource configurations 702 in FIG. 7.

At 1008, the UE may receive a logical channel configuration associated with the SR configuration. For example, 1008 may be performed by logical channel configuration component 1244. For instance, referring to the aforementioned Figures, the UE 902 may receive logical channel configuration 914 from base station 904. The logical channel configuration 914 may include or be associated with a BSR configuration.

At 1010, the UE may receive a message indicating an active status of the SR configuration, where the active status indicates whether the SR configuration is active or inactive. For example, 1010 may be performed by message component 1246. For instance, referring to FIGS. 7 and 9, UE 902 may receive message 916 from base station 904, which message may correspond in some examples to activate resource message 710 or 712. After the base station 904 configures SR configuration 908 for the UE 902 via an RRC configuration, the base station 904 may transmit the message 916 via L1 or L2 signaling to the UE 902 which activates or deactivates the SR configuration 908. For example, the message 916 may include a bit which activates or deactivates the SR configuration 908 for a logical channel depending on whether the bit is 0 or 1.

In one example, the message may indicate another active status of the SR resource configuration received at 1006, and the another active status may indicate whether the SR resource configuration is active or inactive. For instance, referring to FIGS. 7 and 9, after the base station 904 configures SR resource configuration 702, 910 for UE 902 via an RRC configuration, the base station 904 may transmit message 916 via L1 or L2 signaling to the UE 902 which activates or deactivates the SR resource configuration 910. For example, the message 916 may include a bit which activates or deactivates the SR resource configuration 910 for SR configuration 908 depending on whether the bit is 0 or 1.

In one example, the message may indicate a time duration for the active status of the SR configuration. For instance, referring to FIG. 9, the message 916 may specify a duration for activation or deactivation of SR transmissions, which duration may be expressed in units of time or in number of SR occasions. For example, the message 916 may indicate that the UE 902 may transmit SR 926, or refrain from transmitting any SR, for a certain period of time or given number of SR occasions.

In one example, the SR configuration may be associated with a prohibit timer, the message may modify a timer status of the prohibit timer, and the timer status may indicate whether the prohibit timer is started, restarted, or stopped. For instance, referring to FIG. 9, the base station 904 may configure, for each SR configuration 908, at least the following parameters for a scheduling request procedure: a prohibit timer, and a maximum number of SR transmissions. The message 916 may modify the prohibit timer associated with SR configuration 908. For example, the message 916 may start, restart, or stop the prohibit timer associated with an SR configuration in order to control the timing of subsequent SR transmissions.

In one example, the logical channel configuration received at 1008 may indicate a transmission status of the SR, the transmission status may indicate whether a transmission of the SR is enabled, disabled, or delayed in response to available data for a logical channel, and the message may modify the transmission status of the logical channel configuration. For instance, referring to FIG. 9, the UE 902 may receive logical channel configuration 914 associated with SR configuration 908 including a logical channel SR mask, a SR delay timer application flag, and a SR delay timer, and the message 916 may modify logical channel parameters associated with SR configuration 908. For instance, the message 916 may enable, disable, or delay the triggering of SR 926 upon data availability for a logical channel, for example, by toggling the logical channel SR mask or the SR delay timer application flag, or by starting, restarting, or stopping the SR delay timer for that SR configuration.

In one example where a plurality of SR configurations are received (at 1004), the message may indicate the active status of only the SR configuration (received at 1002) or other active statuses of each of the plurality of SR configurations. For instance, in the aforementioned examples, the activation and deactivation may be specific to one SR configuration, or the activation and deactivation may apply to a multitude of SR configurations. For example, as illustrated in the example of FIG. 7, the base station 704 may send one message specifically activating or deactivating SR resource configuration 1, namely activate resource message 710, and another message specifically activating or deactivating SR resource configuration 2, namely activate resource message 712. However, in an alternative example, the activate resource message 710 or 712 may activate or deactivate both SR resource configurations 1 and 2.

In one example, the message may be a unicast message for the UE, a multicast message for a plurality of UEs including the UE, or a broadcast message for a serving cell including the UE. For instance, in the aforementioned examples, the activation and deactivation may be specific to one UE, or the activation and deactivation may be multicast or broadcast signaled to a cell including multiple UEs. For example, as an alternative to the example of FIG. 7, the deactivate resource message 714 may be broadcast to multiple UEs including UE 706 informing these UEs that the base station 704 will not monitor SR resource configuration 1 for SR transmissions from any associated UE (not only UE 706).

In one example, the SR configuration may be associated with a plurality of PUCCH resources for a BWP, and the SR configuration is associated with a logical channel, a SCell beam failure recovery, or a consistent LBT failure recovery. For instance, referring to FIG. 9, the base station 904 may configure multiple PUCCH resources for SR 926 on a given BWP. For instance, the base station 904 may allow the UE 902 to transmit SR 926 in multiple PUCCH resources on a BWP in response to data availability for a logical channel associated with that SR, SCell beam failure recovery, or consistent LBT failure recovery. Thus, even if the base station 904 deactivates one PUCCH resource for a SR, the SR 926 may have at least one other PUCCH resource available for the UE 902 to apply.

In one example, the SR resource configuration received at 1006 may be associated with the SR configuration and configure a parameter for the SR, and the message at 1010 may reconfigure the parameter for the SR. For instance, referring to FIG. 9, after the base station 904 configures SR configuration 908 and SR resource configuration 910 associated with SR configuration 908 via RRC configurations, the base station 904 may modify the parameters of the SR resource configuration 910 dynamically in DCI, MAC-CE, or using some other L1/L2 signaling via message 916. Such parameters may include, for example, a periodicity and an offset of the SR occasions indicated in the SR resource configuration 910.

In one example, the message may indicate an effect time of the SR configuration, and the effect time may indicate when the active status or a reconfiguration of the SR configuration takes effect. For instance, referring to FIG. 9, the base station 904 may provide a DCI, MAC-CE, or other L1/L2 signaling via message 916 which not only informs the UE 902 as to an activation, deactivation, or reconfiguration of SR occasions, but also as to a time delay until when the activation, deactivation, or reconfiguration begins. For example, as an alternative to the example of FIG. 7, the activate resource message 710 may, in addition to activating the SR occasions 708 for SR resource configuration 1, indicate the activation will occur a number of symbols, slots, subframes, SR occasions, or other unit of time after transmission of the activate resource message 710, thereby delaying the initial SR occasion from occurring until after this unit of time has passed.

In one example, the message may activate, deactivate or reconfigure the SR configuration based on a UE capability. For instance, referring to FIG. 9, the UE 902 may indicate in capability information message 906 to the base station 904 that the UE is capable of activating, deactivating, or reconfiguring SR configuration 908, and the base station 904 may configure and transmit a DCI, MAC-CE, or other L1/L2 signaling via message 916 from the base station 904 activating, deactivating, or reconfiguring the SR configuration 908 according to any of the aforementioned examples in response to this indicated UE capability. For example, as an alternative to the example of FIG. 7, the base station 704 may transmit activate resource message 710 to the UE 706 to activate SR occasions 708 in SR resource configuration 1 in response to the UE 706 previously indicating a capability of handling such message from the base station.

At 1012, the UE may receive a DTX configuration associated with a UE transmission configuration and indicating an active time duration for a UE transmission associated with the UE transmission configuration. The UE transmission configuration may be, for example, the SR configuration received at 1002, and the UE transmission may be, for example, the SR associated with the SR configuration. Alternatively or additionally, the UE transmission configuration may be for example, a CG-PUSCH configuration, RACH configuration, or other uplink transmission configuration. The DTX configuration may also indicate a resource for the UE transmission. In one example, the UE may receive the UE transmission configuration associated with the UE transmission in a same message or a different message than a message including the DTX configuration. For example, 1012 may be performed by DTX configuration component 1248. For instance, referring to FIG. 9, the UE 902 may receive DTX configuration 918 from base station 904 which indicates at least an on duration during which the UE 902 may transmit SR 926, and a valid resource in which the UE 902 may transmit SR 926. For example, referring to FIG. 8, in response to receiving the DTX configuration 810, the UE 808 may transmit in valid resources (e.g., SR occasions 802) falling within activity intervals (e.g., on durations 812) indicated in the DTX configuration 810 while discontinuing transmissions outside these intervals.

In one example, the DTX configuration may indicate at least one of: a start time for a DTX cycle, the active time duration during the DTX cycle, an inactive time duration during the DTX cycle, a time delay prior to the start time for the DTX cycle, or a time duration or periodicity of the DTX cycle. For instance, referring to FIGS. 8 and 9, the DTX configuration 810, 918 which the base station 806, 904 provides to the UE 808, 902 may include at least one of the following parameters: a time instant (the start time) where the DTX cycle 816 begins, on duration 812 (the active time duration) within which UE 808 may transmit uplink data on valid resources, off duration 814 (the inactive time duration) within which resources for uplink transmissions by UE 808 are masked, delay 818 (the time delay) before starting the on duration 812 within the DTX cycle 816, and a duration or periodicity of the DTX cycle 816.

In one example, the DTX configuration may indicate a plurality of DTX cycles. For instance, referring to FIGS. 8 and 9, the DTX configuration 810, 918 may also include a plurality of DTX cycles, such as a long DTX cycle and a short DTX cycle. For instance, as an alternative to the example of FIG. 8, the DTX configuration 810 may configure a long DTX cycle corresponding to DTX cycle 816 (having a duration equal to that of DTX cycle 816 illustrated in FIG. 8), and a short DTX cycle smaller than the long DTX cycle which activates in response to activity within the on duration 812 of the long DTX cycle. The short DTX cycle may continue for a configured period of time, after which time if no activity occurs within the on duration, the DTX cycle may revert back to the long DTX cycle.

In one example, the DTX configuration may be associated with or may be for at least one of: SR transmissions of the UE, SR transmissions associated with an SR configuration or a SR resource configuration of the UE, CG-PUSCH transmissions of the UE, CG-PUSCH transmissions associated with a CG configuration, RACH transmissions of the UE, or uplink transmissions of the UE. For instance, referring to FIG. 9, the DTX configuration 918 may be associated with one or more types of transmissions of UE 902. In one example, referring to FIG. 8, the DTX configuration 810 may configure the UE 808 to transmit any SR for any SR configuration in any SR occasion within the on duration 812 but not within the off duration 814. In another example, as an alternative to the example of FIG. 8, the DTX configuration 810 may configure the UE to transmit SRs for at least one specific SR configuration or SR resource configuration (but not in other unspecified SR configurations or SR resource configurations of the UE) in an associated SR occasion within the on duration 812 but not within the off duration 814. In another example, referring to FIG. 8, the DTX configuration 810 may configure the UE 808 to transmit uplink data in response to a configured grant for any configured grant configuration in any CG-PUSCH occasion within the on duration 812 but not within the off duration 814. In another example, as an alternative to the example of FIG. 8, the DTX configuration 810 may configure the UE 808 to transmit uplink data in response to a configured grant for at least one specific configured grant configuration (but not for other unspecified configured grant configurations of the UE) in an associated CG-PUSCH occasion within the on duration 812 but not within the off duration 814. In another example, as an alternative to the example of FIG. 8, the DTX configuration 810 may configure the UE 808 to transmit RACH signals within the on duration 812 but not within the off duration 814. In a further example, as an alternative to the example of FIG. 8, the DTX configuration 810 may configure the UE 808 to transmit any uplink data (e.g., PUCCH data or PUSCH data) within the on duration 812 but not within the off duration 814. In a further example, the DTX configuration 810, 918 may be associated with a combination of any of the foregoing transmissions (e.g., SR, CG-PUSCH, RACH, general UL, etc.).

In one example, the DTX configuration may be associated with uplink transmissions of the UE in a communication resource, the communication resource including at least one of: a BWP, one or more serving cells, a serving cell group, or a frequency range. For instance, referring to FIG. 9, the DTX configuration 918 may be associated with a communication resource for an uplink transmission of the UE 902. For instance, as an alternative to the example of FIG. 8, the DTX configuration 810 may configure the UE 808 to transmit SRs, CG-PUSCH data, RACH signals, PUCCH data, PUSCH data, or other uplink data within the on duration 812 but not the off duration 814 in at least one specific BWP (but not for other unspecified BWPs), in one or more specific serving cells (but not other unspecified serving cells), in at least one specific serving cell group (but not other unspecified serving cell groups), in at least one specific frequency range (but not other unspecified frequency ranges), or a combination of any of the foregoing.

At 1014, the UE may receive another DTX configuration associated with uplink transmissions of the UE, where the another DTX configuration indicates another active time duration that is aligned with the active time duration indicated in the DTX configuration at 1012. For example, 1014 may be performed by DTX configuration component 1248. For instance, referring to FIG. 9, the UE 902 may receive DTX configuration 920 which indicates at least an on duration during which the UE 902 may send uplink transmission 930. In one example, the active time duration of the DTX configuration received at 1012 and the another active time duration of the another DTX configuration received at 1014 are aligned. For instance, as an alternative to the example of FIG. 8, the base station 806 may configure multiple DTX configurations 810 for the UE 808, including one DTX configuration for the SR occasions 802 and one DTX configuration for uplink transmissions other than SR, such that the on durations 812 of the DTX cycles 816 in the respective DTX configurations are aligned.

At 1016, the UE may receive a UE DRX configuration. For example, 1016 may be performed by DRX configuration component 1250. For instance, referring to FIG. 9, the UE 902 may receive DRX configuration 922 which indicates at least an on duration during which the UE 902 may monitor for and receive downlink data from the base station 904. In one example, the DRX configuration may indicate another active time duration, and the active time duration of the DTX configuration received at 1012 and the another active time duration of the UE DRX configuration may be aligned. For instance, as an alternative to the example of FIG. 8, the base station 806 may also configure a UE DRX configuration for the UE 808 along with the DTX configuration 810 such that the on duration 812 of the DTX cycle 816 in the DTX configuration is aligned with the on duration of the DRX cycle in the DRX configuration.

In one example, the DTX configuration received at 1012 may indicate a time extension of the active time duration of a DTX cycle, and the time extension may be triggered in response to uplink or downlink activity during the active time duration. For instance, referring to FIG. 9, the base station 904 may configure time extensions to the on duration of DTX and DRX cycles depending on a network traffic pattern. For instance, as an alternative to the example of FIG. 8, the base station 806 may configure the DTX configuration 810 to include a time extension parameter, such as an inactivity timer, which indicates how long to extend the length of on duration 812 at the UE in response to UE transmission or reception of data during the on duration 812.

In one example, the DRX configuration received at 1016 may indicate a DRX active time duration, the DTX configuration received at 1012 may indicate a time extension of the active time duration of a DTX cycle, and the time extension may be triggered in response to uplink or downlink activity during the DRX active time duration. For instance, referring to FIG. 9, the UE 902 may receive DRX configuration 922 which indicates at least an on duration during which the UE 902 may monitor for and receive downlink data from the base station 904. Similarly, as an alternative to the example of FIG. 8, the base station 806 may configure a DRX configuration for the UE 808 with its own DRX on duration and off duration similar to the DTX configuration 810. In such case, the base station 806 may configure the DTX configuration 810 to include a time extension parameter, such as an inactivity timer, which indicates how long to extend the length of on duration 812 of DTX cycle 816 at the UE in response to UE transmission or reception of data during the DRX on duration.

At 1018, the UE may receive a message associated with the DTX configuration. For example, 1018 may be performed by message component 1246. For instance, referring to FIG. 9, the UE 902 may receive message 924 from base station 904. The message 924 may activate or deactivate, reconfigure, indicate parameters of, or otherwise be associated with DTX configuration 918 via L1 or L2 signaling.

In one example, the UE may receive a semi-static indication or a dynamic indication of a DTX active status for the DTX configuration, where the DTX active status indicates whether the DTX configuration is active or inactive for uplink transmissions of the apparatus or UE. For example, the message received at 1018 may semi-statically or dynamically indicate a DTX active status of the DTX configuration, where the DTX active status indicates whether the DTX configuration is active or inactive. For instance, referring to FIG. 9, the base station 904 may activate or deactivate DTX configuration 918 via message 924. For example, as an alternative to the example of FIG. 8, the base station 806 may transmit an RRC configuration or other layer 3 message, or a DCI, MAC-CE, or other L1 or L2 message, indicating to UE 808 that DTX configuration 810 is active, in response to which the UE and base station may apply the DTX cycle 816 for uplink transmissions in general. Thus, the UE may be semi-statically or dynamically configured to transmit in UE DTX, or the base station may be semi-statically or dynamically configured to receive in cell DRX, general uplink transmissions in on durations of DTX cycle 816 but not in off durations of DTX cycle 816. Later on, the base station may transmit a similar message indicating to UE 808 that DTX configuration 810 is inactive, in response to which the UE and base station may no longer apply DTX cycle 816 for uplink transmissions in general. Thus, the UE may be semi-statically or dynamically configured to transmit in UE DTX, or the base station may be semi-statically or dynamically configured to receive in cell DRX, general uplink transmissions in off durations as well as on durations of DTX cycle 816.

In one example, the UE may receive a semi-static indication or a dynamic indication of an active status for the UE transmission configuration, where the active status indicates whether the UE transmission configuration is active or inactive with respect to the DTX configuration. For example, the message received at 1018, the message received at 1010, the DTX configuration, or the SR or CG-PUSCH or other UE transmission configuration may semi-statically or dynamically indicate with respect to DTX an active status of SR transmissions in general, SR transmissions associated with a specific SR configuration or SR resource configuration, CG-PUSCH transmissions in general, CG-PUSCH transmissions associated with a specific CG-PUSCH configuration (such as type 1 or type 2), RACH transmissions, or other UE transmissions in general or specific to certain UE transmission configurations, where the active status indicates whether the DTX configuration is active or inactive with respect to these specific types of UE transmissions or specific UE transmission configurations.

For instance, referring to FIG. 9, the base station 904 may activate or deactivate application of DTX to an SR configuration, CG-PUSCH configuration, or other UE transmission configuration via message 924, message 916, or other message or configuration. For example, as an alternative to the example of FIG. 8, the base station 806 may transmit an RRC configuration or other layer 3 message, or a DCI, MAC-CE, or other L1 or L2 message, indicating to UE 808 that DTX configuration 810 is active or inactive for SR or CG-PUSCH transmissions in general or per specific SR or CG configurations, in response to which the UE and base station may respectively apply or not apply the DTX cycle 816 for these types of UE transmissions specifically. Thus, the UE may be semi-statically or dynamically configured to transmit in UE DTX, or the base station may be semi-statically or dynamically configured to receive in cell DRX, SR transmissions in general, SR transmissions per SR configuration, CG-PUSCH transmissions in general, or CG-PUSCH transmissions per CG configuration having occasions overlapping with an on duration of DTX cycle 816 but not with an off duration or non-active period of DTX cycle 816 when these transmissions are active with respect to DTX. Similarly, the UE may be semi-statically or dynamically configured to transmit in UE DTX, or the base station may be semi-statically or dynamically configured to receive in cell DRX, SR transmissions in general, SR transmissions per SR configuration, CG-PUSCH transmissions in general, or CG-PUSCH transmissions per CG configuration having occasions overlapping with off durations or non-active periods of DTX cycle 816 as well as with on durations of DTX cycle 816 when these transmissions are inactive with respect to DTX.

In one example, the UE may also receive a semi-static indication or a dynamic indication of another active status for a different configuration associated with another UE transmission, where the another active status indicates whether the different configuration is active or inactive with respect to the another DTX configuration received at 1014. For instance, referring to FIG. 9, the base station 904 may activate or deactivate an SR configuration, CG-PUSCH configuration, or other UE transmission configuration via message 924, message 916, or other message or configuration respectively for multiple DTX configurations 918, 920 having aligned DTX cycles. For example, as an alternative to the example of FIG. 8, the base station 806 may transmit multiple RRC configurations or other layer 3 messages, or multiple DCIs, MAC-CEs, or other L1 or L2 messages, indicating to UE 808 that multiple DTX configurations 810 are active or inactive for SR or CG-PUSCH transmissions respectively in general or per specific SR or CG configurations, in response to which the UE and base station may respectively apply or not apply the aligned DTX cycle for these types of UE transmissions specifically.

In one example, the DTX configuration received at 1012 may further indicate a plurality of DTX cycles, and the message received at 1018 may interrupt or cancel an initial DTX cycle of the plurality of DTX cycles. For instance, referring to FIG. 9, the base station 904 may transmit message 924 which informs the UE 902 to stop applying DTX during an on duration of an initial DTX cycle. For example, as an alternative to the example of FIG. 8, the base station 806 may transmit a DCI, MAC-CE, or other L1 or L2 message indicating to UE 808 to not apply at least a portion of the on duration 812 during the initially configured DTX cycle, and therefore not to transmit any uplink data during this portion or duration, until the next DTX cycle.

In one example, the DTX configuration received at 1012 may include a parameter for the UE transmission, and the message received at 1018 may reconfigure the parameter. For instance, referring to FIG. 9, the base station 904 may transmit message 924 which modifies at least one of a DTX start offset, on duration, off duration, delay, periodicity, or other parameter of DTX configuration 918. Thus, as an alternative to the example of FIG. 8, the base station 806 may transmit a DCI, MAC-CE, or other L1 or L2 message reconfiguring the delay 818 to be longer or shorter than illustrated, the on duration 812 or off duration 814 to be longer or shorter than illustrated, to have a different periodicity for DTX cycle 816, or to include some other reconfiguration.

In one example, the message received at 1018 may activate, deactivate or reconfigure the DTX configuration received at 1012 based on a UE capability. For instance, referring to FIG. 9, the base station 904 may provide DTX configuration 918 to the UE 902, and afterwards the message 924 associated with the DTX configuration 918, in response to identifying from capability information message 906 that the UE 902 is capable of applying DTX. For example, as an alternative to the example of FIG. 8, the UE 808 may initially transmit a capability information message to the base station 806 indicating the UE is capable of supporting DTX in general, DTX for SR configurations in general or for specific SR configurations, DTX for configured grant configurations in general or for specific configured grant configurations, DTX for RACH signals, DTX for general uplink signals, DTX for specific BWPs, DTX for specific serving cells, DTX for specific serving cell groups, DTX for specific frequency ranges, or the like through one or more UE capabilities. In response to receiving this capability information message and determining the UE is capable of DTX in general for example, the base station 806 may configure DTX configuration 810 and provide the DTX configuration to the UE 808 accordingly. Moreover, the base station 806 may provide a DCI, MAC-CE, or other L1 or L2 signaling activating, deactivating, or reconfiguring the DTX configuration 810 according to any of the foregoing examples.

In one example, the message received at 1018 may indicate a parameter associated with the DTX configuration received at 1012, where the message is a SIB or a multi-cast message for a plurality of UEs including the UE. For instance, referring to FIG. 9, the base station 904 may indicate at least one of a DTX start offset, on duration, off duration, delay, periodicity, or other parameter of DTX configuration 918 in an SIB broadcast to UEs in a serving cell including UE 902, or in a multi-cast or groupcast message to certain UEs including UE 902. Here, the SIB or multi-cast/groupcast message may correspond to message 924. Thus, as an alternative to the example of FIG. 8, the base station 806 may initially inform the UE 808 of at least one parameter of the DTX configuration 810, for example delay 818, on duration 812, or off duration 814, via a SIB or multi-cast message to the UE 808 and other UEs.

Finally, at 1020, the UE may transmit the UE transmission during the active time duration indicated in the DTX configuration. For example, 1020 may be performed by uplink component 1252. For instance, referring to FIG. 9, the UE 902 may transmit SR 926 in resources configured by SR configuration 908 and SR resource configuration 910, or transmit CG-PUSCH 928 or uplink transmission 930 in resources respectively configured by associated CG or other configurations, in response to message 916 indicating these configurations are currently active. In one example, the SR, CG-PUSCH, or other UL transmission transmitted at 1020 may be transmitted in the resource of the DTX configuration received at 1012 during the active time duration of the DTX configuration. For instance, referring to FIG. 9, the UE 902 may transmit SR 926, CG-PUSCH 928, or uplink transmission 930 in a resource configured in DTX configuration 918 during a DTX on duration configured in DTX configuration 918.

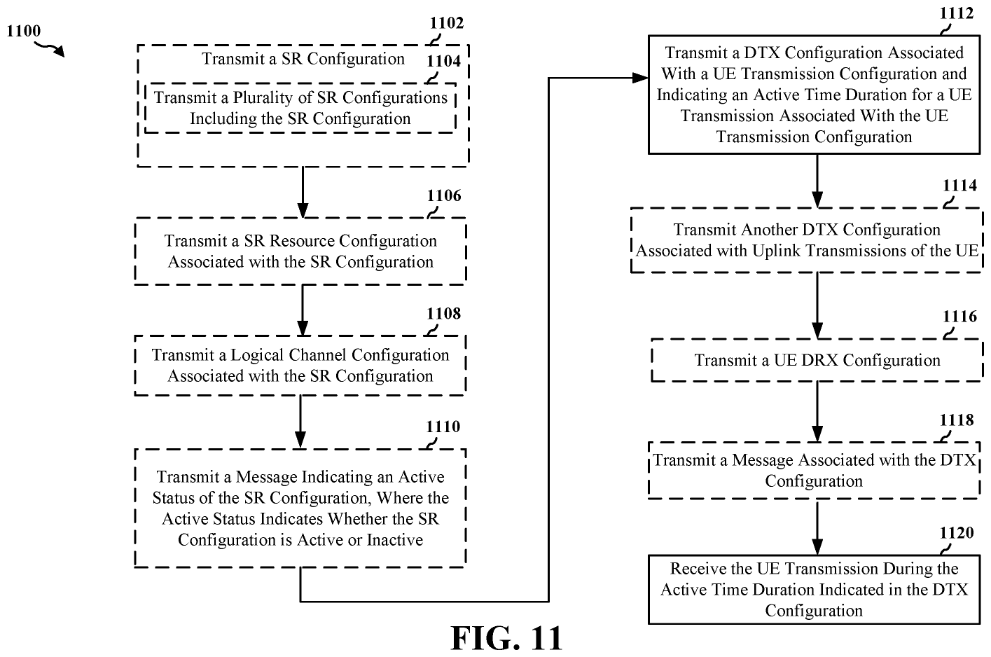

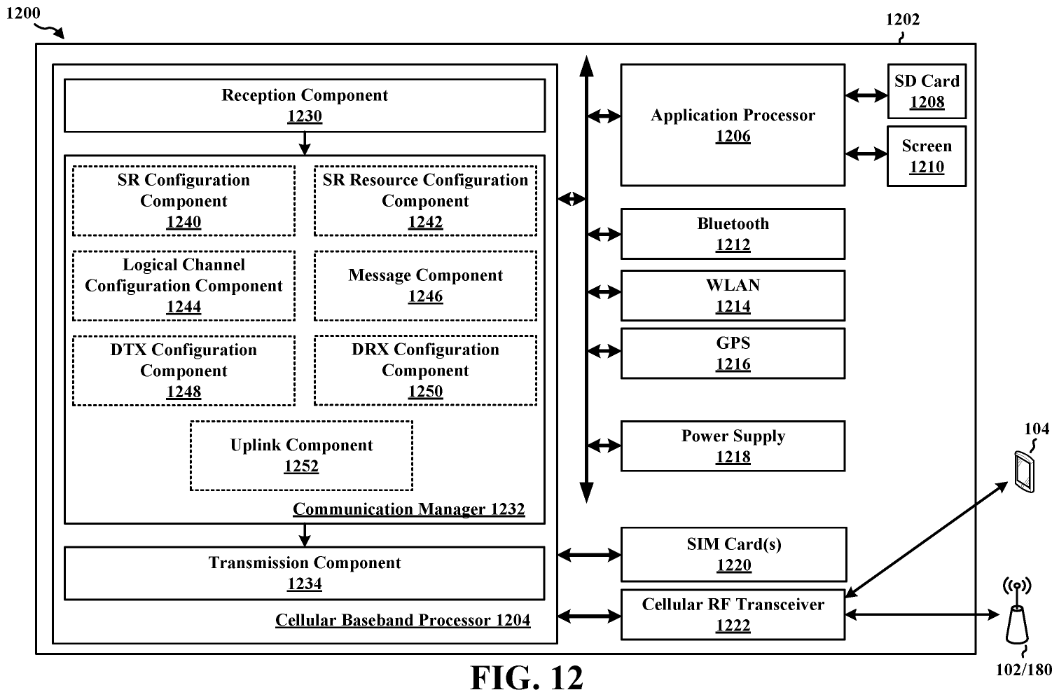

FIG. 11 is a flowchart 1100 of a method of wireless communication. The method may be performed by a network entity such as a base station (e.g., the base station 102/180, 310, 504, 604, 654, 704, 806, 904; the apparatus 1302. Optional aspects are illustrated in dashed lines. The method allows a base station or other network entity to receive an SR or other uplink transmission from a UE in UE DTX or cell DRX, in response to indicating a message of dynamic activation, deactivation, or reconfiguration of the DTX configuration, SR configuration, or other uplink transmission configuration, in order to provide energy savings at the base station.

At 1102, the network entity may transmit a SR configuration associated with an SR. For example, 1102 may be performed by SR configuration component 1340. For instance, at 1104, the base station may transmit a plurality of SR configurations including the SR configuration. For example, 1104 may be performed by SR configuration component 1340. For instance, referring to the aforementioned Figures, the UE 902 may receive one or more SR configuration(s) 908 from base station 904.

At 1106, the network entity may transmit a SR resource configuration associated with the SR configuration. For example, 1106 may be performed by SR resource configuration component 1342. For instance, referring to the aforementioned Figures, the UE 902 may receive SR resource configuration 910 from base station 904, which configuration may correspond in some examples to SR resource configurations 702 in FIG. 7.

At 1108, the network entity may transmit a logical channel configuration associated with the SR configuration. For example, 1108 may be performed by logical channel configuration component 1344. For instance, referring to the aforementioned Figures, the UE 902 may receive logical channel configuration 914 from base station 904. The logical channel configuration 914 may include or be associated with a BSR configuration.

At 1110, the network entity may transmit a message indicating an active status of the SR configuration, where the active status indicates whether the SR configuration is active or inactive. For example, 1110 may be performed by message component 1346. For instance, referring to FIGS. 7 and 9, UE 902 may receive message 916 from base station 904, which message may correspond in some examples to activate resource message 710 or 712. After the base station 904 configures SR configuration 908 for the UE 902 via an RRC configuration, the base station 904 may transmit the message 916 via L1 or L2 signaling to the UE 902 which activates or deactivates the SR configuration 908. For example, the message 916 may include a bit which activates or deactivates the SR configuration 908 for a logical channel depending on whether the bit is 0 or 1.

In one example, the message may indicate another active status of the SR resource configuration transmitted at 1106, and the another active status may indicate whether the SR resource configuration is active or inactive. For instance, referring to FIGS. 7 and 9, after the base station 904 configures SR resource configuration 702, 910 for UE 902 via an RRC configuration, the base station 904 may transmit message 916 via L1 or L2 signaling to the UE 902 which activates or deactivates the SR resource configuration 910. For example, the message 916 may include a bit which activates or deactivates the SR resource configuration 910 for SR configuration 908 depending on whether the bit is 0 or 1.

In one example, the message may indicate a time duration for the active status of the SR configuration. For instance, referring to FIG. 9, the message 916 may specify a duration for activation or deactivation of SR transmissions, which duration may be expressed in units of time or in number of SR occasions. For example, the message 916 may indicate that the UE 902 may transmit SR 926, or refrain from transmitting any SR, for a certain period of time or given number of SR occasions.

In one example, the SR configuration may be associated with a prohibit timer, the message may modify a timer status of the prohibit timer, and the timer status may indicate whether the prohibit timer is started, restarted, or stopped. For instance, referring to FIG. 9, the base station 904 may configure, for each SR configuration 908, at least the following parameters for a scheduling request procedure: a prohibit timer, and a maximum number of SR transmissions. The message 916 may modify the prohibit timer associated with SR configuration 908. For example, the message 916 may start, restart, or stop the prohibit timer associated with an SR configuration in order to control the timing of subsequent SR transmissions.

In one example, the logical channel configuration transmitted at 1108 may indicate a transmission status of the SR, the transmission status may indicate whether a transmission of the SR is enabled, disabled, or delayed in response to available data for a logical channel, and the message may modify the transmission status of the logical channel configuration. For instance, referring to FIG. 9, the UE 902 may receive logical channel configuration 914 associated with SR configuration 908 including a logical channel SR mask, a SR delay timer application flag, and a SR delay timer, and the message 916 may modify logical channel parameters associated with SR configuration 908. For instance, the message 916 may enable, disable, or delay the triggering of SR 926 upon data availability for a logical channel, for example, by toggling the logical channel SR mask or the SR delay timer application flag, or by starting, restarting, or stopping the SR delay timer for that SR configuration.

In one example where a plurality of SR configurations are transmitted (at 1104), the message may indicate the active status of only the SR configuration (transmitted at 1102) or other active statuses of each of the plurality of SR configurations. For instance, in the aforementioned examples, the activation and deactivation may be specific to one SR configuration, or the activation and deactivation may apply to a multitude of SR configurations. For example, as illustrated in the example of FIG. 7, the base station 704 may send one message specifically activating or deactivating SR resource configuration 1, namely activate resource message 710, and another message specifically activating or deactivating SR resource configuration 2, namely activate resource message 712. However, in an alternative example, the activate resource message 710 or 712 may activate or deactivate both SR resource configurations 1 and 2.

In one example, the message may be a unicast message for a UE, a multicast message for a plurality of UEs including the UE, or a broadcast message for a serving cell including the UE. For instance, in the aforementioned examples, the activation and deactivation may be specific to one UE, or the activation and deactivation may be multicast or broadcast signaled to a cell including multiple UEs. For example, as an alternative to the example of FIG. 7, the deactivate resource message 714 may be broadcast to multiple UEs including UE 706 informing these UEs that the base station 704 will not monitor SR resource configuration 1 for SR transmissions from any associated UE (not only UE 706).

In one example, the SR configuration may be associated with a plurality of PUCCH resources for a BWP, and the SR configuration is associated with a logical channel, a SCell beam failure recovery, or a consistent LBT failure recovery. For instance, referring to FIG. 9, the base station 904 may configure multiple PUCCH resources for SR 926 on a given BWP. For instance, the base station 904 may allow the UE 902 to transmit SR 926 in multiple PUCCH resources on a BWP in response to data availability for a logical channel associated with that SR, SCell beam failure recovery, or consistent LBT failure recovery. Thus, even if the base station 904 deactivates one PUCCH resource for a SR, the SR 926 may have at least one other PUCCH resource available for the UE 902 to apply.

In one example, the SR resource configuration transmitted at 1106 may be associated with the SR configuration and configure a parameter for the SR, and the message at 1110 may reconfigure the parameter for the SR. For instance, referring to FIG. 9, after the base station 904 configures SR configuration 908 and SR resource configuration 910 associated with SR configuration 908 via RRC configurations, the base station 904 may modify the parameters of the SR resource configuration 910 dynamically in DCI, MAC-CE, or using some other L1/L2 signaling via message 916. Such parameters may include, for example, a periodicity and an offset of the SR occasions indicated in the SR resource configuration 910.

In one example, the message may indicate an effect time of the SR configuration, and the effect time may indicate when the active status or a reconfiguration of the SR configuration takes effect. For instance, referring to FIG. 9, the base station 904 may provide a DCI, MAC-CE, or other L1/L2 signaling via message 916 which not only informs the UE 902 as to an activation, deactivation, or reconfiguration of SR occasions, but also as to a time delay until when the activation, deactivation, or reconfiguration begins. For example, as an alternative to the example of FIG. 7, the activate resource message 710 may, in addition to activating the SR occasions 708 for SR resource configuration 1, indicate the activation will occur a number of symbols, slots, subframes, SR occasions, or other unit of time after transmission of the activate resource message 710, thereby delaying the initial SR occasion from occurring until after this unit of time has passed.

In one example, the message may activate, deactivate or reconfigure the SR configuration based on a UE capability. For instance, referring to FIG. 9, the UE 902 may indicate in capability information message 906 to the base station 904 that the UE is capable of activating, deactivating, or reconfiguring SR configuration 908, and the base station 904 may configure and transmit a DCI, MAC-CE, or other L1/L2 signaling via message 916 from the base station 904 activating, deactivating, or reconfiguring the SR configuration 908 according to any of the aforementioned examples in response to this indicated UE capability. For example, as an alternative to the example of FIG. 7, the base station 704 may transmit activate resource message 710 to the UE 706 to activate SR occasions 708 in SR resource configuration 1 in response to the UE 706 previously indicating a capability of handling such message from the base station.

At 1112, the network entity may transmit a DTX configuration associated with a UE transmission configuration and indicating an active time duration for a UE transmission associated with the UE transmission configuration. The UE transmission configuration may be, for example, the SR configuration transmitted at 1002, and the UE transmission may be, for example, the SR associated with the SR configuration. Alternatively or additionally, the UE transmission configuration may be for example, a CG-PUSCH configuration, RACH configuration, or other uplink transmission configuration. The DTX configuration may also indicate a resource for the UE transmission. In one example, the network entity may transmit the UE transmission configuration associated with the UE transmission in a same message or a different message than a message including the DTX configuration. For example, 1112 may be performed by DTX configuration component 1348. For instance, referring to FIG. 9, the UE 902 may receive DTX configuration 918 from base station 904 which indicates at least an on duration during which the UE 902 may transmit SR 926, and a valid resource in which the UE 902 may transmit SR 926. For example, referring to FIG. 8, in response to receiving the DTX configuration 810, the UE 808 may transmit in valid resources (e.g., SR occasions 802) falling within activity intervals (e.g., on durations 812) indicated in the DTX configuration 810 while discontinuing transmissions outside these intervals.

In one example, the DTX configuration may indicate at least one of: a start time for a DTX cycle, the active time duration during the DTX cycle, an inactive time duration during the DTX cycle, a time delay prior to the start time for the DTX cycle, or a time duration or periodicity of the DTX cycle. For instance, referring to FIGS. 8 and 9, the DTX configuration 810, 918 which the base station 806, 904 provides to the UE 808, 902 may include at least one of the following parameters: a time instant (the start time) where the DTX cycle 816 begins, on duration 812 (the active time duration) within which UE 808 may transmit uplink data on valid resources, off duration 814 (the inactive time duration) within which resources for uplink transmissions by UE 808 are masked, delay 818 (the time delay) before starting the on duration 812 within the DTX cycle 816, and a duration or periodicity of the DTX cycle 816.

In one example, the DTX configuration may indicate a plurality of DTX cycles. For instance, referring to FIGS. 8 and 9, the DTX configuration 810, 918 may also include a plurality of DTX cycles, such as a long DTX cycle and a short DTX cycle. For instance, as an alternative to the example of FIG. 8, the DTX configuration 810 may configure a long DTX cycle corresponding to DTX cycle 816 (having a duration equal to that of DTX cycle 816 illustrated in FIG. 8), and a short DTX cycle smaller than the long DTX cycle which activates in response to activity within the on duration 812 of the long DTX cycle. The short DTX cycle may continue for a configured period of time, after which time if no activity occurs within the on duration, the DTX cycle may revert back to the long DTX cycle.

In one example, the DTX configuration may be associated with or may be for at least one of: SR transmissions of the UE, SR transmissions associated with an SR configuration or a SR resource configuration of the UE, CG-PUSCH transmissions of the UE, CG-PUSCH transmissions associated with a CG configuration, RACH transmissions of the UE, or uplink transmissions of the UE. For instance, referring to FIG. 9, the DTX configuration 918 may be associated with one or more types of transmissions of UE 902. In one example, referring to FIG. 8, the DTX configuration 810 may configure the UE 808 to transmit any SR for any SR configuration in any SR occasion within the on duration 812 but not within the off duration 814. In another example, as an alternative to the example of FIG. 8, the DTX configuration 810 may configure the UE to transmit SRs for at least one specific SR configuration or SR resource configuration (but not in other unspecified SR configurations or SR resource configurations of the UE) in an associated SR occasion within the on duration 812 but not within the off duration 814. In another example, referring to FIG. 8, the DTX configuration 810 may configure the UE 808 to transmit uplink data in response to a configured grant for any configured grant configuration in any CG-PUSCH occasion within the on duration 812 but not within the off duration 814. In another example, as an alternative to the example of FIG. 8, the DTX configuration 810 may configure the UE 808 to transmit uplink data in response to a configured grant for at least one specific configured grant configuration (but not for other unspecified configured grant configurations of the UE) in an associated CG-PUSCH occasion within the on duration 812 but not within the off duration 814. In another example, as an alternative to the example of FIG. 8, the DTX configuration 810 may configure the UE 808 to transmit RACH signals within the on duration 812 but not within the off duration 814. In a further example, as an alternative to the example of FIG. 8, the DTX configuration 810 may configure the UE 808 to transmit any uplink data (e.g., PUCCH data or PUSCH data) within the on duration 812 but not within the off duration 814. In a further example, the DTX configuration 810, 918 may be associated with a combination of any of the foregoing transmissions (e.g., SR, CG-PUSCH, RACH, general UL, etc.).

In one example, the DTX configuration may be associated with uplink transmissions of the UE in a communication resource, the communication resource including at least one of: a BWP, one or more serving cells, a serving cell group, or a frequency range. For instance, referring to FIG. 9, the DTX configuration 918 may be associated with a communication resource for an uplink transmission of the UE 902. For instance, as an alternative to the example of FIG. 8, the DTX configuration 810 may configure the UE 808 to transmit SRs, CG-PUSCH data, RACH signals, PUCCH data, PUSCH data, or other uplink data within the on duration 812 but not the off duration 814 in at least one specific BWP (but not for other unspecified BWPs), in one or more specific serving cells (but not other unspecified serving cells), in at least one specific serving cell group (but not other unspecified serving cell groups), in at least one specific frequency range (but not other unspecified frequency ranges), or a combination of any of the foregoing.

At 1114, the network entity may transmit another DTX configuration associated with uplink transmissions of the UE, where the another DTX configuration indicates another active time duration that is aligned with the active time duration indicated in the DTX configuration at 1112. For example, 1114 may be performed by DTX configuration component 1348. For instance, referring to FIG. 9, the UE 902 may receive DTX configuration 920 which indicates at least an on duration during which the UE 902 may send uplink transmission 930. In one example, the active time duration of the DTX configuration received at 1012 and the another active time duration of the another DTX configuration received at 1014 are aligned. For instance, as an alternative to the example of FIG. 8, the base station 806 may configure multiple DTX configurations 810 for the UE 808, including one DTX configuration for the SR occasions 802 and one DTX configuration for uplink transmissions other than SR, such that the on durations 812 of the DTX cycles 816 in the respective DTX configurations are aligned.

At 1116, the network entity may transmit a UE DRX configuration. For example, 1116 may be performed by DRX configuration component 1350. For instance, referring to FIG. 9, the UE 902 may receive DRX configuration 922 which indicates at least an on duration during which the UE 902 may monitor for and receive downlink data from the base station 904. In one example, the DRX configuration may indicate another active time duration, and the active time duration of the DTX configuration received at 1012 and the another active time duration of the DRX configuration may be aligned. For instance, as an alternative to the example of FIG. 8, the base station 806 may also configure a UE DRX configuration for the UE 808 along with the DTX configuration 810 such that the on duration 812 of the DTX cycle 816 in the DTX configuration is aligned with the on duration of the DRX cycle in the DRX configuration.

In one example, the DTX configuration transmitted at 1112 may indicate a time extension of the active time duration of a DTX cycle, and the time extension may be triggered in response to uplink or downlink activity during the active time duration. For instance, referring to FIG. 9, the base station 904 may configure time extensions to the on duration of DTX and DRX cycles depending on a network traffic pattern. For instance, as an alternative to the example of FIG. 8, the base station 806 may configure the DTX configuration 810 to include a time extension parameter, such as an inactivity timer, which indicates how long to extend the length of on duration 812 at the UE in response to UE transmission or reception of data during the on duration 812.

In one example, the DRX configuration transmitted at 1116 may indicate a DRX active time duration, the DTX configuration transmitted at 1112 may indicate a time extension of the active time duration of a DTX cycle, and the time extension may be triggered in response to uplink or downlink activity during the DRX active time duration. For instance, referring to FIG. 9, the UE 902 may receive DRX configuration 922 which indicates at least an on duration during which the UE 902 may monitor for and receive downlink data from the base station 904. Similarly, as an alternative to the example of FIG. 8, the base station 806 may configure a DRX configuration for the UE 808 with its own DRX on duration and off duration similar to the DTX configuration 810. In such case, the base station 806 may configure the DTX configuration 810 to include a time extension parameter, such as an inactivity timer, which indicates how long to extend the length of on duration 812 of DTX cycle 816 at the UE in response to UE transmission or reception of data during the DRX on duration.

At 1118, the network entity may transmit a message associated with the DTX configuration. For example, 1118 may be performed by message component 1346. For instance, referring to FIG. 9, the UE 902 may receive message 924 from base station 904. The message 924 may activate or deactivate, reconfigure, indicate parameters of, or otherwise be associated with DTX configuration 918 via L1 or L2 signaling.

In one example, the network entity may transmit a semi-static indication or a dynamic indication of a DTX active status for the DTX configuration, where the DTX active status indicates whether the DTX configuration is active or inactive for uplink transmissions of the UE. For example, the message transmitted at 1118 may semi-statically or dynamically indicate a DTX active status of the DTX configuration, where the DTX active status indicates whether the DTX configuration is active or inactive. For instance, referring to FIG. 9, the base station 904 may activate or deactivate DTX configuration 918 via message 924. For example, as an alternative to the example of FIG. 8, the base station 806 may transmit an RRC configuration or other layer 3 message, or a DCI, MAC-CE, or other L1 or L2 message, indicating to UE 808 that DTX configuration 810 is active, in response to which the UE and base station may apply the DTX cycle 816 for uplink transmissions in general. Thus, the UE may be semi-statically or dynamically configured to transmit in UE DTX, or the base station may be semi-statically or dynamically configured to receive in cell DRX, general uplink transmissions in on durations of DTX cycle 816 but not in off durations of DTX cycle 816. Later on, the base station may transmit a similar message indicating to UE 808 that DTX configuration 810 is inactive, in response to which the UE and base station may no longer apply DTX cycle 816 for uplink transmissions in general. Thus, the UE may be semi-statically or dynamically configured to transmit in UE DTX, or the base station may be semi-statically or dynamically configured to receive in cell DRX, general uplink transmissions in off durations as well as on durations of DTX cycle 816.

In one example, the network entity may transmit a semi-static indication or a dynamic indication of an active status for the UE transmission configuration, where the active status indicates whether the UE transmission configuration is active or inactive with respect to the DTX configuration. For example, the message transmitted at 1118, the message transmitted at 1110, the DTX configuration, or the SR or CG-PUSCH or other UE transmission configuration may semi-statically or dynamically indicate with respect to DTX an active status of SR transmissions in general, SR transmissions associated with a specific SR configuration or SR resource configuration, CG-PUSCH transmissions in general, CG-PUSCH transmissions associated with a specific CG-PUSCH configuration (such as type 1 or type 2), RACH transmissions, or other UE transmissions in general or specific to certain UE transmission configurations, where the active status indicates whether the DTX configuration is active or inactive with respect to these specific types of UE transmissions or specific UE transmission configurations.

For instance, referring to FIG. 9, the base station 904 may activate or deactivate application of DTX to an SR configuration, CG-PUSCH configuration, or other UE transmission configuration via message 924, message 916, or other message or configuration. For example, as an alternative to the example of FIG. 8, the base station 806 may transmit an RRC configuration or other layer 3 message, or a DCI, MAC-CE, or other L1 or L2 message, indicating to UE 808 that DTX configuration 810 is active or inactive for SR or CG-PUSCH transmissions in general or per specific SR or CG configurations, in response to which the UE and base station may respectively apply or not apply the DTX cycle 816 for these types of UE transmissions specifically. Thus, the UE may be semi-statically or dynamically configured to transmit in UE DTX, or the base station may be semi-statically or dynamically configured to receive in cell DRX, SR transmissions in general, SR transmissions per SR configuration, CG-PUSCH transmissions in general, or CG-PUSCH transmissions per CG configuration having occasions overlapping with an on duration of DTX cycle 816 but not with an off duration or non-active period of DTX cycle 816 when these transmissions are active with respect to DTX. Similarly, the UE may be semi-statically or dynamically configured to transmit in UE DTX, or the base station may be semi-statically or dynamically configured to receive in cell DRX, SR transmissions in general, SR transmissions per SR configuration, CG-PUSCH transmissions in general, or CG-PUSCH transmissions per CG configuration having occasions overlapping with off durations or non-active periods of DTX cycle 816 as well as with on durations of DTX cycle 816 when these transmissions are inactive with respect to DTX.

In one example, the network entity may also transmit a semi-static indication or a dynamic indication of another active status for a different configuration associated with another UE transmission, where the another active status indicates whether the different configuration is active or inactive with respect to the another DTX configuration received at 1014. For instance, referring to FIG. 9, the base station 904 may activate or deactivate an SR configuration, CG-PUSCH configuration, or other UE transmission configuration via message 924, message 916, or other message or configuration respectively for multiple DTX configurations 918, 920 having aligned DTX cycles. For example, as an alternative to the example of FIG. 8, the base station 806 may transmit multiple RRC configurations or other layer 3 messages, or multiple DCIs, MAC-CEs, or other L1 or L2 messages, indicating to UE 808 that multiple DTX configurations 810 are active or inactive for SR or CG-PUSCH transmissions respectively in general or per specific SR or CG configurations, in response to which the UE and base station may respectively apply or not apply the aligned DTX cycle for these types of UE transmissions specifically.

In one example, the DTX configuration transmitted at 1112 may further indicate a plurality of DTX cycles, and the message transmitted at 1118 may interrupt or cancel an initial DTX cycle of the plurality of DTX cycles. For instance, referring to FIG. 9, the base station 904 may transmit message 924 which informs the UE 902 to stop applying DTX during an on duration of an initial DTX cycle. For example, as an alternative to the example of FIG. 8, the base station 806 may transmit a DCI, MAC-CE, or other L1 or L2 message indicating to UE 808 to not apply at least a portion of the on duration 812 during the initially configured DTX cycle, and therefore not to transmit any uplink data during this portion or duration, until the next DTX cycle.

In one example, the DTX configuration transmitted at 1112 may include a parameter for the UE transmission, and the message transmitted at 1118 may reconfigure the parameter. For instance, referring to FIG. 9, the base station 904 may transmit message 924 which modifies at least one of a DTX start offset, on duration, off duration, delay, periodicity, or other parameter of DTX configuration 918. Thus, as an alternative to the example of FIG. 8, the base station 806 may transmit a DCI, MAC-CE, or other L1 or L2 message reconfiguring the delay 818 to be longer or shorter than illustrated, the on duration 812 or off duration 814 to be longer or shorter than illustrated, to have a different periodicity for DTX cycle 816, or to include some other reconfiguration.

In one example, the message transmitted at 1118 may activate, deactivate or reconfigure the DTX configuration received at 1012 based on a UE capability. For instance, referring to FIG. 9, the base station 904 may provide DTX configuration 918 to the UE 902, and afterwards the message 924 associated with the DTX configuration 918, in response to identifying from capability information message 906 that the UE 902 is capable of applying DTX. For example, as an alternative to the example of FIG. 8, the UE 808 may initially transmit a capability information message to the base station 806 indicating the UE is capable of supporting DTX in general, DTX for SR configurations in general or for specific SR configurations, DTX for configured grant configurations in general or for specific configured grant configurations, DTX for RACH signals, DTX for general uplink signals, DTX for specific BWPs, DTX for specific serving cells, DTX for specific serving cell groups, DTX for specific frequency ranges, or the like through one or more UE capabilities. In response to receiving this capability information message and determining the UE is capable of DTX in general for example, the base station 806 may configure DTX configuration 810 and provide the DTX configuration to the UE 808 accordingly. Moreover, the base station 806 may provide a DCI, MAC-CE, or other L1 or L2 signaling activating, deactivating, or reconfiguring the DTX configuration 810 according to any of the foregoing examples.

In one example, the message transmitted at 1118 may indicate a parameter associated with the DTX configuration received at 1012, where the message is a SIB or a multi-cast message for a plurality of UEs including the UE. For instance, referring to FIG. 9, the base station 904 may indicate at least one of a DTX start offset, on duration, off duration, delay, periodicity, or other parameter of DTX configuration 918 in an SIB broadcast to UEs in a serving cell including UE 902, or in a multi-cast or groupcast message to certain UEs including UE 902. Here, the SIB or multi-cast/groupcast message may correspond to message 924. Thus, as an alternative to the example of FIG. 8, the base station 806 may initially inform the UE 808 of at least one parameter of the DTX configuration 810, for example delay 818, on duration 812, or off duration 814, via a SIB or multi-cast message to the UE 808 and other UEs.

Finally, at 1120, the network entity may receive the UE transmission during the active time duration indicated in the DTX configuration. For example, 1120 may be performed by uplink component 1352. For instance, referring to FIG. 9, the UE 902 may transmit SR 926 in resources configured by SR configuration 908 and SR resource configuration 910, or transmit CG-PUSCH 928 or uplink transmission 930 in resources respectively configured by associated CG or other configurations, in response to message 916 indicating these configurations are currently active. In one example, the SR, CG-PUSCH, or other UL transmission received at 1120 may be received in the resource of the DTX configuration transmitted at 1112 during the active time duration of the DTX configuration. For instance, referring to FIG. 9, the UE 902 may transmit SR 926, CG-PUSCH 928, or uplink transmission 930 in a resource configured in DTX configuration 918 during a DTX on duration configured in DTX configuration 918.

FIG. 12 is a diagram 1200 illustrating an example of a hardware implementation for an apparatus 1202. The apparatus 1202 is a UE and includes a cellular baseband processor 1204 (also referred to as a modem) coupled to a cellular RF transceiver 1222 and one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, and a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., see 350 of FIG. 3) and include the aforediscussed additional modules of the apparatus 1202.

The communication manager 1232 includes a SR configuration component 1240 that is configured to receive a SR configuration associated with an SR, e.g., as described in connection with 1002. The SR configuration component 1240 is further configured to receive a plurality of SR configurations including the SR configuration, e.g., as described in connection with 1004.

The communication manager 1232 further includes a SR resource configuration component 1242 that is configured to receive a SR resource configuration associated with the SR configuration, e.g., as described in connection with 1006. The SR resource configuration component 1242 is further configured to receive a SR resource configuration associated with the SR configuration and configure a parameter for the SR, where the message reconfigures the parameter for the SR, e.g., as described in connection with 1006 and 1010.

The communication manager 1232 further includes a logical channel configuration component 1244 that is configured to receive a logical channel configuration associated with the SR configuration, e.g., as described in connection with 1008.

The communication manager 1232 further includes a message component 1246 that is configured to receive a message indicating an active status of the SR configuration, e.g., as described in connection with 1010. The message component 1246 is further configured to receive another message associated with the DTX configuration, e.g., as described in connection 1018. For example, the another message may indicate a DTX active status of the DTX configuration, an active status of a UE transmission configuration with respect to the DTX configuration, or the another message may indicate a parameter associated with the DTX configuration.

The communication manager 1232 further includes a DTX configuration component 1248 that is configured to receive a DTX configuration associated with a UE transmission configuration and indicating an active time duration for a UE transmission associated with the UE transmission configuration, e.g., as described in connection with 1012. The DTX configuration component 1248 is further configured to receive another DTX configuration associated with uplink transmissions of the UE, e.g., as described in connection with 1014.

The communication manager 1232 further includes a DRX configuration component 1250 that is configured to receive a UE DRX configuration, e.g., as described in connection with 1016. The DRX configuration may indicate a DRX active time duration.

The communication manager 1232 further includes an uplink component 1252 that is configured to transmit the UE transmission during the active time duration indicated in the DTX configuration, e.g., as described in connection with 1020.

The apparatus may include additional components that perform each of the blocks of the algorithm in the aforementioned flowchart of FIG. 10. As such, each block in the aforementioned flowchart of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the cellular baseband processor 1204, includes means for receiving a DTX configuration associated with a UE transmission configuration and indicating an active time duration for a UE transmission associated with the UE transmission configuration; and means for transmitting the UE transmission during the active time duration indicated in the DTX configuration.

In one configuration, the apparatus 1202, and in particular the cellular baseband processor 1204, includes means for receiving a semi-static indication or a dynamic indication of a DTX active status for the DTX configuration, the DTX active status indicating whether the DTX configuration is active or inactive for uplink transmissions of the apparatus.

In one configuration, the apparatus 1202, and in particular the cellular baseband processor 1204, includes means for receiving a semi-static indication or a dynamic indication of an active status for the UE transmission configuration, the active status indicating whether the UE transmission configuration is active or inactive with respect to the DTX configuration.

In one configuration, the apparatus 1202, and in particular the cellular baseband processor 1204, includes means for receiving the UE transmission configuration associated with the UE transmission in a same message or a different message than a message including the DTX configuration.

In one configuration, the apparatus 1202, and in particular the cellular baseband processor 1204, includes means for receiving another DTX configuration indicating another active time duration aligned with the active time duration; and means for receiving a semi-static indication or a dynamic indication of another active status for a different configuration associated with another UE transmission, the another active status indicating whether the different configuration is active or inactive with respect to the another DTX configuration.

In one configuration, the apparatus 1202, and in particular the cellular baseband processor 1204, includes means for receiving a SR configuration; means for receiving a message indicating an active status of the SR configuration, wherein the active status indicates whether the SR configuration is active or inactive; and means for transmitting a SR associated with the SR configuration based on the message.

In one configuration, the apparatus 1202, and in particular the cellular baseband processor 1204, may include means for receiving a SR resource configuration associated with the SR configuration.

In one configuration, the apparatus 1202, and in particular the cellular baseband processor 1204, may include means for receiving a logical channel configuration associated with the SR configuration, wherein the logical channel configuration indicates a transmission status of the SR, and the transmission status indicates whether a transmission of the SR is enabled, disabled, or delayed in response to available data for a logical channel.

In one configuration, the means for receiving the SR configuration may further be configured to receive a plurality of SR configurations including the SR configuration.

In one configuration, the means for receiving the SR resource configuration may further be configured to receive a SR resource configuration associated with the SR configuration and configuring a parameter for the SR.

In one configuration, the apparatus 1202, and in particular the cellular baseband processor 1204, may include means for receiving a DTX configuration indicating an active time duration for a UE transmission and a resource for the UE transmission.

In one configuration, the means for receiving the DTX configuration may further be configured to receive another DTX configuration associated with uplink transmissions of the UE.

In one configuration, the apparatus 1202, and in particular the cellular baseband processor 1204, may include means for receiving a DRX configuration.

In one configuration, the means for receiving the DRX configuration may further be configured to receive a DRX configuration indicating a DRX active time duration.

In one configuration, the means for receiving the message may further be configured to receive another message indicating a DTX active status of the DTX configuration, wherein the DTX active status indicates whether the DTX configuration is active or inactive.

In one configuration, the means for receiving the message may further be configured to receive another message associated with the DTX configuration.

In one configuration, the means for receiving the message may further be configured to receive another message activating, deactivating or reconfiguring the DTX configuration based on a UE capability.

In one configuration, the means for receiving the message may further be configured to receive another message indicating a parameter associated with the DTX configuration, wherein the another message is a SIB or a multi-cast message for a plurality of UEs including the UE.

The aforementioned means may be one or more of the aforementioned components of the apparatus 1202 configured to perform the functions recited by the aforementioned means. As described supra, the apparatus 1202 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

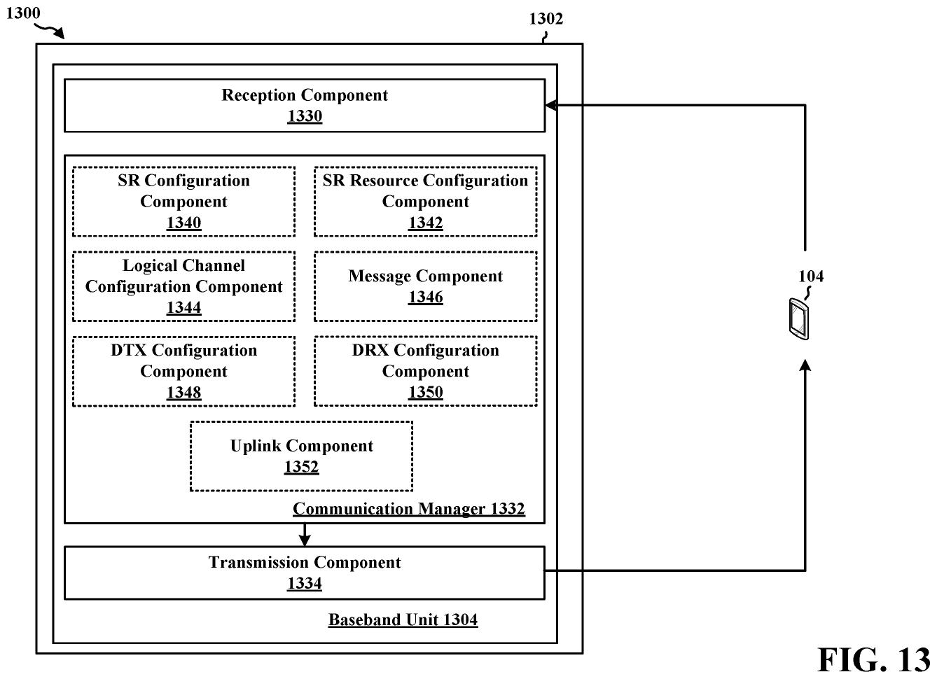

FIG. 13 is a diagram 1300 illustrating an example of a hardware implementation for an apparatus 1302. The apparatus 1302 is a BS and includes a baseband unit 1304. The baseband unit 1304 may communicate through a cellular RF transceiver with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the BS 310 and may include the memory 376 and/or at least one of the TX processor 316, the RX processor 370, and the controller/processor 375.

The communication manager 1332 includes a SR configuration component 1340 that is configured to transmit a SR configuration associated with an SR, e.g., as described in connection with 1102. The SR configuration component 1340 is further configured to transmit a plurality of SR configurations including the SR configuration, e.g., as described in connection with 1104.

The communication manager 1332 further includes a SR resource configuration component 1342 that is configured to transmit a SR resource configuration associated with the SR configuration, e.g., as described in connection with 1106. The SR resource configuration component 1342 is further configured to transmit a SR resource configuration associated with the SR configuration and configure a parameter for the SR, where the message reconfigures the parameter for the SR, e.g., as described in connection with 1106 and 1110.

The communication manager 1332 further includes a logical channel configuration component 1344 that is configured to transmit a logical channel configuration associated with the SR configuration, e.g., as described in connection with 1108.

The communication manager 1332 further includes a message component 1346 that is configured to transmit a message indicating an active status of the SR configuration, e.g., as described in connection with 1110. The message component 1346 is further configured to transmit another message associated with the DTX configuration, e.g., as described in connection 1118. For example, the another message may indicate a DTX active status of the DTX configuration, an active status of a UE transmission configuration with respect to the DTX configuration, or the another message may indicate a parameter associated with the DTX configuration.

The communication manager 1332 further includes a DTX configuration component 1348 that is configured to transmit a DTX configuration associated with a UE transmission configuration and indicating an active time duration for a UE transmission associated with the UE transmission configuration, e.g., as described in connection with 1112. The DTX configuration component 1348 is further configured to transmit another DTX configuration associated with uplink transmissions of the UE, e.g., as described in connection with 1114.

The communication manager 1332 further includes a DRX configuration component 1350 that is configured to transmit a UE DRX configuration, e.g., as described in connection with 1116. The DRX configuration may indicate a DRX active time duration.

The communication manager 1332 further includes an uplink component 1352 that is configured to receive the UE transmission during the active time duration indicated in the DTX configuration, e.g., as described in connection with 1120.

The apparatus may include additional components that perform each of the blocks of the algorithm in the aforementioned flowchart of FIG. 11. As such, each block in the aforementioned flowcharts of FIG. 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes means for transmitting a DTX configuration associated with a UE transmission configuration and indicating an active time duration for a UE transmission associated with the UE transmission configuration; and means for receiving the UE transmission during the active time duration indicated in the DTX configuration.

In one configuration, the apparatus 1302, and in particular the baseband unit 1304, includes means for transmitting a semi-static indication or a dynamic indication of a DTX active status for the DTX configuration, the DTX active status indicating whether the DTX configuration is active or inactive for uplink transmissions of the apparatus.

In one configuration, the apparatus 1302, and in particular the baseband unit 1304, includes means for transmitting a semi-static indication or a dynamic indication of an active status for the UE transmission configuration, the active status indicating whether the UE transmission configuration is active or inactive with respect to the DTX configuration.

In one configuration, the apparatus 1302, and in particular the baseband unit 1304, includes means for transmitting the UE transmission configuration associated with the UE transmission in a same message or a different message than a message including the DTX configuration.

In one configuration, the apparatus 1302, and in particular the baseband unit 1304, includes means for transmitting another DTX configuration indicating another active time duration aligned with the active time duration; and means for transmitting a semi-static indication or a dynamic indication of another active status for a different configuration associated with another UE transmission, the another active status indicating whether the different configuration is active or inactive with respect to the another DTX configuration.

In one configuration, the apparatus 1302, and in particular the baseband unit 1304, includes means for transmitting a SR configuration; means for transmitting a message indicating an active status of the SR configuration, wherein the active status indicates whether the SR configuration is active or inactive; and means for receiving a SR associated with the SR configuration based on the message.

In one configuration, the apparatus 1302, and in particular the baseband unit 1304, may include means for transmitting a SR resource configuration associated with the SR configuration.

In one configuration, the apparatus 1302, and in particular the baseband unit 1304, may include means for transmitting a logical channel configuration associated with the SR configuration, wherein the logical channel configuration indicates a transmission status of the SR, and the transmission status indicates whether a transmission of the SR is enabled, disabled, or delayed in response to available data for a logical channel.

In one configuration, the means for transmitting the SR configuration may further be configured to transmitting a plurality of SR configurations including the SR configuration.

In one configuration, the means for transmitting the SR resource configuration may further be configured to transmit a SR resource configuration associated with the SR configuration and configuring a parameter for the SR.

In one configuration, the apparatus 1302, and in particular the baseband unit 1304, may include means for transmitting a DTX configuration indicating an active time duration for a UE transmission and a resource for the UE transmission.

In one configuration, the means for transmitting the DTX configuration may further be configured to transmit another DTX configuration associated with uplink transmissions of the UE.

In one configuration, the apparatus 1302, and in particular the baseband unit 1304, may include means for transmitting a DRX configuration.

In one configuration, the means for transmitting the DRX configuration may further be configured to transmit a DRX configuration indicating a DRX active time duration.

In one configuration, the means for transmitting the message may further be configured to transmit another message indicating a DTX active status of the DTX configuration, wherein the DTX active status indicates whether the DTX configuration is active or inactive.

In one configuration, the means for transmitting the message may further be configured to transmit another message associated with the DTX configuration.

In one configuration, the means for transmitting the message may further be configured to transmit another message activating, deactivating or reconfiguring the DTX configuration based on a UE capability.

In one configuration, the means for transmitting the message may further be configured to transmit another message indicating a parameter associated with the DTX configuration, wherein the another message is a SIB or a multi-cast message for a plurality of UEs including the UE.

The aforementioned means may be one or more of the aforementioned components of the apparatus 1302 configured to perform the functions recited by the aforementioned means. As described supra, the apparatus 1302 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is an apparatus for wireless communication, comprising: a processor; memory coupled with the processor; and instructions stored in the memory and operable, when executed by the processor, to cause the apparatus to: receive a scheduling request (SR) configuration; receive a message indicating an active status of the SR configuration, wherein the active status indicates whether the SR configuration is active or inactive; and transmit a SR associated with the SR configuration based on the message.

Example 2 is the apparatus of Example 1, wherein the instructions, when executed by the processor, further cause the apparatus to: receive a SR resource configuration associated with the SR configuration, wherein the message indicates another active status of the SR resource configuration, and the another active status indicates whether the SR resource configuration is active or inactive.

Example 3 is the apparatus of Examples 1 or 2, wherein the message indicates a time duration for the active status of the SR configuration.

Example 4 is the apparatus of any of Examples 1 to 3, wherein the SR configuration is associated with a prohibit timer, the message modifies a timer status of the prohibit timer, and the timer status indicates whether the prohibit timer is started, restarted, or stopped.

Example 5 is the apparatus of any of Examples 1 to 4, wherein the instructions, when executed by the processor, further cause the apparatus to: receive a logical channel configuration associated with the SR configuration, wherein the logical channel configuration indicates a transmission status of the SR, the transmission status indicates whether a transmission of the SR is enabled, disabled, or delayed in response to available data for a logical channel, and the message modifies the transmission status of the logical channel configuration.

Example 6 is the apparatus of any of Examples 1 to 5, wherein the instructions, when executed by the processor, further cause the apparatus to: receive a plurality of SR configurations including the SR configuration, wherein the message indicates the active status of only the SR configuration or other active statuses of each of the plurality of SR configurations.

Example 7 is the apparatus of any of Examples 1 to 6, wherein the apparatus is a user equipment (UE), and wherein the message is a unicast message for the UE, a multicast message for a plurality of UEs including the UE, or a broadcast message for a serving cell including the UE.

Example 8 is the apparatus of any of Examples 1 to 7, wherein the SR configuration is associated with a plurality of physical uplink control channel (PUCCH) resources for a bandwidth part (BWP), and the SR configuration is associated with a logical channel, a secondary cell (SCell) beam failure recovery, or a consistent listen-before-talk (LBT) failure recovery.

Example 9 is the apparatus of any of Examples 1 to 8, wherein the instructions, when executed by the processor, further cause the apparatus to: receive a SR resource configuration associated with the SR configuration and configuring a parameter for the SR, wherein the message reconfigures the parameter for the SR.

Example 10 is the apparatus of any of Examples 1 to 9, wherein the message indicates an effect time of the SR configuration, and the effect time indicates when the active status or a reconfiguration of the SR configuration takes effect.

Example 11 is the apparatus of any of Examples 1 to 10, wherein the message activates, deactivates or reconfigures the SR configuration based on a user equipment (UE) capability.

Example 12 is the apparatus of any of Examples 1 to 11, wherein the instructions, when executed by the processor, further cause the apparatus to: receive a discontinuous transmission (DTX) configuration indicating an active time duration for a user equipment (UE) transmission and a resource for the UE transmission, wherein the SR is transmitted in the resource during the active time duration.

Example 13 is the apparatus of Example 12, wherein the DTX configuration indicates at least one of: a start time for a DTX cycle; the active time duration during the DTX cycle; an inactive time duration during the DTX cycle; a time delay prior to the start time for the DTX cycle; or a time duration or periodicity of the DTX cycle.

Example 14 is the apparatus of Example 12 or 13, wherein the DTX configuration indicates a plurality of DTX cycles.

Example 15 is the apparatus of any of Examples 12 to 14, wherein the apparatus is a UE, and the DTX configuration is associated with at least one of: SR transmissions of the UE; SR transmissions associated with the SR configuration or a SR resource configuration of the UE; configured grant (CG) physical uplink shared channel (PUSCH) (CG-PUSCH) transmissions of the UE; CG-PUSCH transmissions associated with a CG configuration; random access channel (RACH) transmissions of the UE; or uplink transmissions of the UE.

Example 16 is the apparatus of any of Examples 12 to 15, wherein the apparatus is a UE, and the DTX configuration is associated with uplink transmissions of the UE in a communication resource, the communication resource including at least one of: a bandwidth part (BWP); one or more serving cells; a serving cell group; or a frequency range.

Example 17 is the apparatus of any of Examples 12 to 16, wherein the apparatus is a UE, and the instructions, when executed by the processor, further cause the apparatus to: receive another DTX configuration associated with uplink transmissions of the UE; wherein the another DTX configuration indicates another active time duration, and the active time duration of the DTX configuration and the another active time duration of the another DTX configuration are aligned.

Example 18 is the apparatus of any of Examples 12 to 17, wherein the instructions, when executed by the processor, further cause the apparatus to: receive a discontinuous reception (DRX) configuration; wherein the DRX configuration indicates another active time duration, and the active time duration of the DTX configuration and the another active time duration of the DRX configuration are aligned.

Example 19 is the apparatus of any of Examples 12 to 18, wherein the DTX configuration indicates a time extension of the active time duration of a DTX cycle, and the time extension is triggered in response to uplink or downlink activity during the active time duration.

Example 20 is the apparatus of any of Examples 12 to 19, wherein the instructions, when executed by the processor, further cause the apparatus to: receive a discontinuous reception (DRX) configuration indicating a DRX active time duration; wherein the DTX configuration indicates a time extension of the active time duration of a DTX cycle, and the time extension is triggered in response to uplink or downlink activity during the DRX active time duration.

Example 21 is the apparatus of any of Examples 12 to 20, wherein the instructions, when executed by the processor, further cause the apparatus to: receive another message indicating a DTX active status of the DTX configuration, wherein the DTX active status indicates whether the DTX configuration is active or inactive.

Example 22 is the apparatus of any of Examples 12 to 21, wherein the instructions, when executed by the processor, further cause the apparatus to: receive another message associated with the DTX configuration; wherein the DTX configuration further indicates a plurality of DTX cycles, and the another message interrupts or cancels an initial DTX cycle of the plurality of DTX cycles.

Example 23 is the apparatus of any of Examples 12 to 22, wherein the instructions, when executed by the processor, further cause the apparatus to: receive another message associated with the DTX configuration; wherein the DTX configuration includes a parameter for the UE transmission, and the another message reconfigures the parameter.

Example 24 is the apparatus of any of Examples 12 to 23, wherein the instructions, when executed by the processor, further cause the apparatus to: receive another message activating, deactivating or reconfiguring the DTX configuration based on a UE capability.

Example 25 is the apparatus of any of Examples 12 to 24, wherein the apparatus is a UE, and the instructions, when executed by the processor, further cause the apparatus to: receive another message indicating a parameter associated with the DTX configuration, wherein the another message is a system information block (SIB) or a multi-cast message for a plurality of UEs including the UE.

Example 26 is an apparatus for wireless communication, comprising: a processor; memory coupled with the processor; and instructions stored in the memory and operable, when executed by the processor, to cause the apparatus to: transmit a scheduling request (SR) configuration; transmit a message indicating an active status of the SR configuration, wherein the active status indicates whether the SR configuration is active or inactive; and receive a SR associated with the SR configuration based on the message.

Example 27 is the apparatus of Example 26, wherein the instructions, when executed by the processor, further cause the apparatus to: transmit a SR resource configuration associated with the SR configuration, wherein the message indicates another active status of the SR resource configuration, and the another active status indicates whether the SR resource configuration is active or inactive.

Example 28 is the apparatus of Examples 26 or 27, wherein the message indicates a time duration for the active status of the SR configuration.

Example 29 is the apparatus of any of Examples 26 to 28, wherein the SR configuration is associated with a prohibit timer, the message modifies a timer status of the prohibit timer, and the timer status indicates whether the prohibit timer is started, restarted, or stopped.

Example 30 is the apparatus of any of Examples 26 to 29, wherein the instructions, when executed by the processor, further cause the apparatus to: transmit a logical channel configuration associated with the SR configuration, wherein the logical channel configuration indicates a transmission status of the SR, and the transmission status indicates whether a transmission of the SR is enabled, disabled, or delayed in response to available data for a logical channel, and the message modifies the transmission status of the logical channel configuration.

Example 31 is the apparatus of any of Examples 26 to 30, wherein the instructions, when executed by the processor, further cause the apparatus to: transmit a plurality of SR configurations including the SR configuration, wherein the message indicates the active status of only the SR configuration or other active statuses of each of the plurality of SR configurations.

Example 32 is the apparatus of any of Examples 26 to 31, wherein the message is a unicast message for a user equipment (UE), a multicast message for a plurality of UEs including the UE, or a broadcast message for a serving cell including the UE.

Example 33 is the apparatus of any of Examples 26 to 32, wherein the SR configuration is associated with a plurality of physical uplink control channel (PUCCH) resources for a bandwidth part (BWP), and the SR configuration is associated with a logical channel, a secondary cell (SCell) beam failure recovery, or a consistent listen-before-talk (LBT) failure recovery.

Example 34 is the apparatus of any of Examples 26 to 33, wherein the instructions, when executed by the processor, further cause the apparatus to: transmit a SR resource configuration associated with the SR configuration and configuring a parameter for the SR, wherein the message reconfigures the parameter for the SR.

Example 35 is the apparatus of any of Examples 26 to 34, wherein the message indicates an effect time of the SR configuration, and the effect time indicates when the active status or a reconfiguration of the SR configuration takes effect.

Example 36 is the apparatus of any of Examples 26 to 35, wherein the message activates, deactivates or reconfigures the SR configuration based on a user equipment (UE) capability.

Example 37 is the apparatus of any of Examples 26 to 36, wherein the instructions, when executed by the processor, further cause the apparatus to: transmit a discontinuous transmission (DTX) configuration indicating an active time duration for a user equipment (UE) transmission and a resource for the UE transmission, wherein the SR is received in the resource during the active time duration.

Example 38 is the apparatus of Example 37, wherein the DTX configuration indicates at least one of: a start time for a DTX cycle; the active time duration during the DTX cycle; an inactive time duration during the DTX cycle; a time delay prior to the start time for the DTX cycle; or a time duration or periodicity of the DTX cycle.

Example 39 is the apparatus of Examples 37 or 38, wherein the DTX configuration indicates a plurality of DTX cycles.

Example 40 is the apparatus of any of Examples 37 to 39, wherein the DTX configuration is associated with at least one of: SR transmissions of a UE; SR transmissions associated with the SR configuration or a SR resource configuration of the UE; configured grant (CG) physical uplink shared channel (PUSCH) (CG-PUSCH) transmissions of the UE; CG-PUSCH transmissions associated with a CG configuration; random access channel (RACH) transmissions of the UE; or uplink transmissions of the UE.

Example 41 is the apparatus of any of Examples 37 to 40, wherein the DTX configuration is associated with uplink transmissions of a UE in a communication resource, the communication resource including at least one of: a bandwidth part (BWP); one or more serving cells; a serving cell group; or a frequency range.

Example 42 is the apparatus of any of Examples 37 to 41, wherein the instructions, when executed by the processor, further cause the apparatus to: transmit another DTX configuration associated with uplink transmissions of a UE; wherein the another DTX configuration indicates another active time duration, and the active time duration of the DTX configuration and the another active time duration of the another DTX configuration are aligned.

Example 43 is the apparatus of any of Examples 37 to 42, wherein the instructions, when executed by the processor, further cause the apparatus to: transmit a discontinuous reception (DRX) configuration; wherein the DRX configuration indicates another active time duration, and the active time duration of the DTX configuration and the another active time duration of the DRX configuration are aligned.

Example 44 is the apparatus of any of Examples 37 to 43, wherein the DTX configuration indicates a time extension of the active time duration of a DTX cycle, and the time extension is triggered in response to uplink or downlink activity during the active time duration.

Example 45 is the apparatus of any of Examples 37 to 44, wherein the instructions, when executed by the processor, further cause the apparatus to: transmit a discontinuous reception (DRX) configuration indicating a DRX active time duration; wherein the DTX configuration indicates a time extension of the active time duration of a DTX cycle, and the time extension is triggered in response to uplink or downlink activity during the DRX active time duration.

Example 46 is the apparatus of any of Examples 37 to 45, wherein the instructions, when executed by the processor, further cause the apparatus to: transmit another message indicating a DTX active status of the DTX configuration, wherein the DTX active status indicates whether the DTX configuration is active or inactive.

Example 47 is the apparatus of any of Examples 37 to 46, wherein the instructions, when executed by the processor, further cause the apparatus to: transmit another message associated with the DTX configuration; wherein the DTX configuration further indicates a plurality of DTX cycles, and the another message interrupts or cancels an initial DTX cycle of the plurality of DTX cycles.

Example 48 is the apparatus of any of Examples 37 to 47, wherein the instructions, when executed by the processor, further cause the apparatus to: transmit another message associated with the DTX configuration; wherein the DTX configuration includes a parameter for the UE transmission, and the another message reconfigures the parameter.

Example 49 is the apparatus of any of Examples 37 to 48, wherein the instructions, when executed by the processor, further cause the apparatus to: transmit another message activating, deactivating or reconfiguring the DTX configuration based on a UE capability.

Example 50 is the apparatus of any of Examples 37 to 49, wherein the instructions, when executed by the processor, further cause the apparatus to: transmit another message indicating a parameter associated with the DTX configuration, wherein the another message is a system information block (SIB) or a multi-cast message for a plurality of UEs.

Example 51 is an apparatus for wireless communication comprising means for performing the steps described in any of Examples 1 to 25.

Example 52 is an apparatus for wireless communication comprising means for performing the steps described in any of Examples 26 to 50.

Example 53 is a method of wireless communication at a UE comprising the steps described in any of Examples 1 to 25.

Example 54 is a method of wireless communication at a base station comprising the steps described in any of Examples 26 to 50.

Example 55 is a non-transitory computer-readable medium storing computer executable code, the code when executed by a processor cause the processor to perform the steps described in any of Examples 1 to 25.

Example 56 is a non-transitory computer-readable medium storing computer executable code, the code when executed by a processor cause the processor to perform the steps described in any of Examples 26 to 50.

Example 57 is an apparatus for wireless communication, comprising: a processor; memory coupled with the processor; and instructions stored in the memory and operable, when executed by the processor, to cause the apparatus to: receive a DTX configuration associated with a UE transmission configuration and indicating an active time duration for a UE transmission associated with the UE transmission configuration; and transmit the UE transmission during the active time duration indicated in the DTX configuration.

Example 58 is the apparatus of Example 57, wherein the instructions, when executed by the processor, further cause the apparatus to: receive a semi-static indication or a dynamic indication of a DTX active status for the DTX configuration, the DTX active status indicating whether the DTX configuration is active or inactive for uplink transmissions of the apparatus.

Example 59 is the apparatus of Examples 57 or 58, wherein the apparatus is a UE, and the DTX configuration is for at least one of: SR transmissions of the UE; the SR transmissions associated with an SR configuration or an SR resource configuration of the UE; CG-PUSCH transmissions of the UE; the CG-PUSCH transmissions associated with a CG configuration; RACH transmissions of the UE; or other uplink transmissions of the UE.

Example 60 is the apparatus of any of Examples 57 to 59, wherein the instructions, when executed by the processor, further cause the apparatus to: receive a semi-static indication or a dynamic indication of an active status for the UE transmission configuration, the active status indicating whether the UE transmission configuration is active or inactive with respect to the DTX configuration.

Example 61 is the apparatus of any of Examples 57 to 60, wherein the instructions, when executed by the processor, further cause the apparatus to: receive the UE transmission configuration associated with the UE transmission in a same message or a different message than a message including the DTX configuration.

Example 62 is the apparatus of any of Examples 57 to 61, wherein the instructions, when executed by the processor, further cause the apparatus to: receive another DTX configuration indicating another active time duration aligned with the active time duration; and receive a semi-static indication or a dynamic indication of another active status for a different configuration associated with another UE transmission, the another active status indicating whether the different configuration is active or inactive with respect to the another DTX configuration.

Example 63 is the apparatus of any of Examples 57 to 62, wherein the instructions, when executed by the processor, further cause the apparatus to: receive a UE DRX configuration; wherein the DRX configuration indicates another active time duration, and the active time duration of the DTX configuration and the another active time duration of the UE DRX configuration are aligned.

Example 64 is the apparatus of any of Examples 57 to 63, wherein the instructions, when executed by the processor, further cause the apparatus to: receive a message associated with the DTX configuration; wherein the DTX configuration includes a parameter for the UE transmission, and the message reconfigures the parameter.

Example 65 is the apparatus of any of Examples 57 to 64, wherein the instructions, when executed by the processor, further cause the apparatus to: receive a DRX configuration indicating a DRX active time duration; wherein the DTX configuration indicates a time extension of the active time duration of a DTX cycle, and the time extension is triggered in response to uplink or downlink activity during the DRX active time duration.

Example 66 is the apparatus of any of Examples 57 to 65, wherein the DTX configuration indicates at least one of: a start time for a DTX cycle; the active time duration during the DTX cycle; an inactive time duration during the DTX cycle; a time delay prior to the start time for the DTX cycle; or a time duration or periodicity of the DTX cycle.

Example 67 is the apparatus of any of Examples 57 to 66, wherein the DTX configuration indicates a time extension of the active time duration of a DTX cycle, and the time extension is triggered in response to uplink or downlink activity during the active time duration.

Example 68 is the apparatus of any of Examples 57 to 67, wherein the UE transmission configuration is a SR configuration, the UE transmission is an SR, and the instructions, when executed by the processor, further cause the apparatus to: receive the SR configuration associated with the SR; and receive a message indicating an active status of the SR configuration, the active status indicating whether the SR configuration is active or inactive.

Example 69 is the apparatus of Example 68, wherein the instructions, when executed by the processor, further cause the apparatus to: receive a SR resource configuration associated with the SR configuration, wherein the message indicates another active status of the SR resource configuration, and the another active status indicates whether the SR resource configuration is active or inactive.

Example 70 is the apparatus of Examples 68 or 69, wherein the message indicates a time duration for the active status of the SR configuration.

Example 72 is the apparatus of any of Examples 68 to 70, wherein the SR configuration is associated with a prohibit timer, the message modifies a timer status of the prohibit timer, and the timer status indicates whether the prohibit timer is started, restarted, or stopped.

Example 73 is the apparatus of any of Examples 68 to 72, wherein the instructions, when executed by the processor, further cause the apparatus to: receive a logical channel configuration associated with the SR configuration, wherein the logical channel configuration indicates a transmission status of the SR, the transmission status indicates whether a transmission of the SR is enabled, disabled, or delayed in response to available data for a logical channel, and the message modifies the transmission status of the logical channel configuration.

Example 74 is the apparatus of any of Examples 68 to 73, wherein the instructions, when executed by the processor, further cause the apparatus to: receive a plurality of SR configurations including the SR configuration, wherein the message indicates the active status of only the SR configuration or other active statuses of each of the plurality of SR configurations.

Example 75 is the apparatus of any of Examples 68 to 74, wherein the apparatus is a UE, and wherein the message is a unicast message for the UE, a multicast message for a plurality of UEs including the UE, or a broadcast message for a serving cell including the UE.

Example 76 is the apparatus of any of Examples 68 to 75, wherein the SR configuration is associated with a plurality of PUCCH resources for a BWP, and the SR configuration is associated with a logical channel, a SCell beam failure recovery, or a consistent LBT failure recovery.

Example 77 is the apparatus of any of Examples 68 to 76, wherein the instructions, when executed by the processor, further cause the apparatus to: receive a SR resource configuration associated with the SR configuration and configuring a parameter for the SR, wherein the message reconfigures the parameter for the SR.

Example 78 is the apparatus of any of Examples 68 to 77, wherein the message indicates an effect time of the SR configuration, and the effect time indicates when the active status or a reconfiguration of the SR configuration takes effect.

Example 79 is the apparatus of any of Examples 68 to 78, wherein the message activates, deactivates or reconfigures the SR configuration based on a UE capability.

Example 80 is an apparatus for wireless communication, comprising: a processor; memory coupled with the processor; and instructions stored in the memory and operable, when executed by the processor, to cause the apparatus to: transmit a DTX configuration associated with a UE transmission configuration and indicating an active time duration for a UE transmission associated with the UE transmission configuration; and receive the UE transmission during the active time duration indicated in the DTX configuration.

Example 81 is the apparatus of Example 80, wherein the instructions, when executed by the processor, further cause the apparatus to: transmit a semi-static indication or a dynamic indication of a DTX active status for the DTX configuration, the DTX active status indicating whether the DTX configuration is active or inactive for uplink transmissions of a UE.

Example 82 is the apparatus of Examples 80 or 81, wherein the DTX configuration is for at least one of: SR transmissions of a UE; the SR transmissions associated with an SR configuration or an SR resource configuration of the UE; CG-PUSCH transmissions of the UE; the CG-PUSCH transmissions associated with a CG configuration; RACH transmissions of the UE; or other uplink transmissions of the UE.

Example 83 is the apparatus of any of Examples 80 to 82, wherein the instructions, when executed by the processor, further cause the apparatus to: transmit a semi-static indication or a dynamic indication of an active status for the UE transmission configuration associated with the UE transmission, the active status indicating whether the UE transmission configuration is active or inactive with respect to the DTX configuration.

Example 84 is the apparatus of any of Examples 80 to 83, wherein the instructions, when executed by the processor, further cause the apparatus to: transmit another DTX configuration indicating another active time duration aligned with the active time duration; and transmit a semi-static indication or a dynamic indication of another active status for a different configuration associated with another UE transmission, the another active status indicating whether the different configuration is active or inactive with respect to the another DTX configuration.

Example 85 is the apparatus of any of Examples 80 to 84, wherein the instructions, when executed by the processor, further cause the apparatus to: transmit a UE DRX configuration; wherein the DRX configuration indicates another active time duration, and the active time duration of the DTX configuration and the another active time duration of the UE DRX configuration are aligned.

Example 86 is a method of wireless communication at a UE, comprising: receiving a DTX configuration associated with a UE transmission configuration and indicating an active time duration for a UE transmission associated with the UE transmission configuration; and transmitting the UE transmission during the active time duration indicated in the DTX configuration.

Example 87 is a method of wireless communication at a network entity, comprising: transmitting a DTX configuration associated with a UE transmission configuration and indicating an active time duration for a UE transmission associated with the UE transmission configuration; and receiving the UE transmission during the active time duration indicated in the DTX configuration.

What is claimed is:

1. An apparatus for wireless communication, comprising:
a processor;
memory coupled with the processor; and
instructions stored in the memory and operable, when executed by the processor, to cause the apparatus to:
receive a discontinuous transmission (DTX) configuration associated with a user equipment (UE) transmission configuration and indicating an active time duration for a UE transmission associated with the UE transmission configuration; and
transmit the UE transmission during the active time duration indicated in the DTX configuration.

2. The apparatus of claim 1, wherein the instructions, when executed by the processor, further cause the apparatus to:
receive a semi-static indication or a dynamic indication of a DTX active status for the DTX configuration, the DTX active status indicating whether the DTX configuration is active or inactive for uplink transmissions of the apparatus.

3. The apparatus of claim 1, wherein the apparatus is a UE, and the DTX configuration is for at least one of:
scheduling request (SR) transmissions of the UE;
the SR transmissions associated with an SR configuration or an SR resource configuration of the UE;
configured grant (CG) physical uplink shared channel (PUSCH) (CG-PUSCH) transmissions of the UE;
the CG-PUSCH transmissions associated with a CG configuration;
random access channel (RACH) transmissions of the UE; or
other uplink transmissions of the UE.

4. The apparatus of claim 1, wherein the instructions, when executed by the processor, further cause the apparatus to:
receive a semi-static indication or a dynamic indication of an active status for the UE transmission configuration, the active status indicating whether the UE transmission configuration is active or inactive with respect to the DTX configuration.

5. The apparatus of claim 4, wherein the instructions, when executed by the processor, further cause the apparatus to:
receive the UE transmission configuration associated with the UE transmission in a same message or a different message than a message including the DTX configuration.

6. The apparatus of claim 4, wherein the instructions, when executed by the processor, further cause the apparatus to:
receive another DTX configuration indicating another active time duration aligned with the active time duration; and
receive a semi-static indication or a dynamic indication of another active status for a different configuration associated with another UE transmission, the another active status indicating whether the different configuration is active or inactive with respect to the another DTX configuration.

7. The apparatus of claim 1, wherein the instructions, when executed by the processor, further cause the apparatus to:
receive a UE discontinuous reception (DRX) configuration;
wherein the DRX configuration indicates another active time duration, and the active time duration of the DTX configuration and the another active time duration of the UE DRX configuration are aligned.

8. The apparatus of claim 1, wherein the instructions, when executed by the processor, further cause the apparatus to:
receive a message associated with the DTX configuration;
wherein the DTX configuration includes a parameter for the UE transmission, and the message reconfigures the parameter.

9. The apparatus of claim 1, wherein the instructions, when executed by the processor, further cause the apparatus to:
receive a discontinuous reception (DRX) configuration indicating a DRX active time duration;
wherein the DTX configuration indicates a time extension of the active time duration of a DTX cycle, and the time extension is triggered in response to uplink or downlink activity during the DRX active time duration.

10. The apparatus of claim 1, wherein the DTX configuration indicates at least one of:
a start time for a DTX cycle;
the active time duration during the DTX cycle;
an inactive time duration during the DTX cycle;
a time delay prior to the start time for the DTX cycle; or
a time duration or periodicity of the DTX cycle.

11. The apparatus of claim 1, wherein the DTX configuration indicates a time extension of the active time duration of a DTX cycle, and the time extension is triggered in response to uplink or downlink activity during the active time duration.

12. The apparatus of claim 1, wherein the UE transmission configuration is a scheduling request (SR) configuration, the UE transmission is an SR, and the instructions, when executed by the processor, further cause the apparatus to:
receive the SR configuration associated with the SR; and
receive a message indicating an active status of the SR configuration, the active status indicating whether the SR configuration is active or inactive.

13. The apparatus of claim 12, wherein the instructions, when executed by the processor, further cause the apparatus to:
receive a SR resource configuration associated with the SR configuration, wherein the message indicates another active status of the SR resource configuration, and the another active status indicates whether the SR resource configuration is active or inactive.

14. The apparatus of claim 12, wherein the message indicates a time duration for the active status of the SR configuration.

15. The apparatus of claim 12, wherein the SR configuration is associated with a prohibit timer, the message modifies a timer status of the prohibit timer, and the timer status indicates whether the prohibit timer is started, restarted, or stopped.

16. The apparatus of claim 12, wherein the instructions, when executed by the processor, further cause the apparatus to:
receive a logical channel configuration associated with the SR configuration, wherein the logical channel configuration indicates a transmission status of the SR, the transmission status indicates whether a transmission of the SR is enabled, disabled, or delayed in response to available data for a logical channel, and the message modifies the transmission status of the logical channel configuration.

17. The apparatus of claim 12, wherein the instructions, when executed by the processor, further cause the apparatus to:
receive a plurality of SR configurations including the SR configuration, wherein the message indicates the active status of only the SR configuration or other active statuses of each of the plurality of SR configurations.

18. The apparatus of claim 12,
wherein the apparatus is a UE, and
wherein the message is a unicast message for the UE, a multicast message for a plurality of UEs including the UE, or a broadcast message for a serving cell including the UE.

19. The apparatus of claim 12, wherein the SR configuration is associated with a plurality of physical uplink control channel (PUCCH) resources for a bandwidth part (BWP), and the SR configuration is associated with a logical channel, a secondary cell (SCell) beam failure recovery, or a consistent listen-before-talk (LBT) failure recovery.

20. The apparatus of claim 12, wherein the instructions, when executed by the processor, further cause the apparatus to:
receive a SR resource configuration associated with the SR configuration and configuring a parameter for the SR, wherein the message reconfigures the parameter for the SR.

21. The apparatus of claim 12, wherein the message indicates an effect time of the SR configuration, and the effect time indicates when the active status or a reconfiguration of the SR configuration takes effect.

22. The apparatus of claim 12, wherein the message activates, deactivates or reconfigures the SR configuration based on a UE capability.

23. An apparatus for wireless communication, comprising:
a processor;
memory coupled with the processor; and
instructions stored in the memory and operable, when executed by the processor, to cause the apparatus to:
transmit a discontinuous transmission (DTX) configuration associated with a user equipment (UE) transmission configuration and indicating an active time duration for a UE transmission associated with the UE transmission configuration; and
receive the UE transmission during the active time duration indicated in the DTX configuration.

24. The apparatus of claim 23, wherein the instructions, when executed by the processor, further cause the apparatus to:
transmit a semi-static indication or a dynamic indication of a DTX active status for the DTX configuration, the DTX active status indicating whether the DTX configuration is active or inactive for uplink transmissions of a UE.

25. The apparatus of claim 23, wherein the DTX configuration is for at least one of:
scheduling request (SR) transmissions of a UE;
the SR transmissions associated with an SR configuration or an SR resource configuration of the UE;
configured grant (CG) physical uplink shared channel (PUSCH) (CG-PUSCH) transmissions of the UE;
the CG-PUSCH transmissions associated with a CG configuration;
random access channel (RACH) transmissions of the UE; or
other uplink transmissions of the UE.

26. The apparatus of claim 23, wherein the instructions, when executed by the processor, further cause the apparatus to:
transmit a semi-static indication or a dynamic indication of an active status for the UE transmission configuration associated with the UE transmission, the active status indicating whether the UE transmission configuration is active or inactive with respect to the DTX configuration.

27. The apparatus of claim 26, wherein the instructions, when executed by the processor, further cause the apparatus to:
transmit another DTX configuration indicating another active time duration aligned with the active time duration; and
transmit a semi-static indication or a dynamic indication of another active status for a different configuration associated with another UE transmission, the another active status indicating whether the different configuration is active or inactive with respect to the another DTX configuration.

28. The apparatus of claim 23, wherein the instructions, when executed by the processor, further cause the apparatus to:
transmit a UE discontinuous reception (DRX) configuration;
wherein the DRX configuration indicates another active time duration, and the active time duration of the DTX configuration and the another active time duration of the UE DRX configuration are aligned.

29. A method of wireless communication at a user equipment (UE), comprising:
receiving a discontinuous transmission (DTX) configuration associated with a user equipment (UE) transmission configuration and indicating an active time duration for a UE transmission associated with the UE transmission configuration; and
transmitting the UE transmission during the active time duration indicated in the DTX configuration.

30. A method of wireless communication at a network entity, comprising:
transmitting a discontinuous transmission (DTX) configuration associated with a user equipment (UE) transmission configuration and indicating an active time duration for a UE transmission associated with the UE transmission configuration; and
receiving the UE transmission during the active time duration indicated in the DTX configuration.
